(19) United States
(12) Patent Application Publication
(10) Pub. No.: US 2024/0220984 A1
(43) Pub. Date: Jul. 4, 2024

(54) A METHOD, SYSTEM AND APPARATUS FOR APPROVING ELECTRONIC TRANSACTIONS

(71) Applicant: OneSpan NV, Grimbergen (Strombeck-Bever) (BE)

(72) Inventors: Andreas GUTMANN, Grimbergen (Strombeck-Bever) (BE); Steven MURDOCH, Grimbergen (Strombeck-Bever) (BE)

(73) Assignee: OneSpan NV, Grimbergen (Strombeck-Bever) (BE)

(21) Appl. No.: 18/563,300

(22) PCT Filed: May 27, 2022
(86) PCT No.: PCT/EP2022/064500

§ 371 Date: Nov. 21, 2023

(30) Foreign Application Priority Data
May 27, 2021 (EP) 21020282.6
Dec. 31, 2021 (EP) 21020661.1
Jan. 1, 2022 (EP) 22150001.0

(51) Int. Cl. G06Q 20/40; G06Q 20/38

(52) U.S. Cl. CPC G06Q 20/401; G06Q 20/3825

(57) ABSTRACT

Methods, apparatus and systems for authenticating and approving an electronic transaction are disclosed. A client access device is caused to provide an output, by using a user output interface of the client access device, to a user of the client access device wherein the output comprises a first representation of a client transaction data set, and wherein the first representation of the client transaction data set is in a format that is adapted to make it possible for human users perceiving the output to retrieve the represented client transaction data. A client authentication device captures, from the user output interface of the client access device, the output of the client access device. The client authentication device generates or otherwise obtains a transaction approval code that is linked to a second representation of the client transaction data set and makes the generated or obtained transaction approval code available for transfer to an authentication server, wherein the client authentication device uses the output captured by the client authentication device to generate or otherwise obtain the transaction approval code and make the generated or obtained transaction approval code available for transfer.

### FIELD OF THE INVENTION

The invention relates to a method, system and apparatus for securing the interaction between a user and a remotely accessible computer-based application. More in particular, the invention relates to authenticating an electronic transaction submitted or approved by a user to a remotely accessible computer-based application.

### BACKGROUND OF THE INVENTION

Many computer-based applications process some type of transactions. In many cases a transaction processing computer-based application interacts with human users whereby such a user can submit to the transaction processing computer-based application a transaction together with an implicit or explicit approval of the submitted transaction or whereby a user can approve a transaction that is presented to that user by the transaction processing computer-based application. Typically, the transaction processing computer-based application completes or proceeds with the processing of the transaction when it has received the user's approval for the transaction. In what follows a transaction processing computer-based application that interacts with human users as described above may be referred to as a computer-based application or even simply as an application. The transactions processed by a computer-based application are characterized or defined by a set of data that in this description is referred to as a transaction data set or simply as the transaction data. Since the transactions in this description are processed by a computer-based application they may also be referred to in this description as electronic transactions. In many cases such a computer-based application is remotely accessible by a user through a client access device that may be connected through a computer network to a computer system hosting the computer-based application. In what follows, the client access device may also be referred to as the access device. For example, many remotely accessible computer-based applications can be accessed through a web interface of the computer-based applications by means of a web browser on the user's client access device. A typical example is an internet banking web site that users can access over the internet by means of a web browser on their client access device such as, for example, their Personal Computer (PC) or laptop, whereby users can submit for example money transfer orders to transfer money from one of their bank accounts to some other bank account (typically held by some other user). Other examples of computer-based applications in the sense of this description include internet retail sites where users can submit orders to purchase goods or services and pay for these ordered goods or services, or investment sites where users can for example trade stocks.

In many cases such a computer-based application may be the target of fraudsters desirous to inject into the computer-based application fraudulent transactions or to fraudulently manipulate and/or alter existing transactions. For example, in the case of an internet banking website, a fraudster might try to submit a fraudulent money transfer order for the transfer of an amount of money from the account of a legitimate user to an account belonging to or controlled by the fraudster.

User Authentication. As a minimum barrier to such attempts of fraud, many computer-based applications implement some form of user authorization, i.e., whereby a user is restricted to submit only certain types of transactions (for example only money transfers from an account that is registered with the computer-based application as belonging to that user), in combination with user authentication, i.e., whereby a user must first login and provide some evidence of his/her identity before the computer-based application will make it possible for the user to submit any transaction. Many user authentication mechanisms are known and being used, such as user id and static password, dynamic or one-time passwords that may be generated by so-called strong authentication tokens, biometric authentication, authentication protocols based on PKI (Public Key Infrastructure) certificates and public-private key pairs, . . . .

MITMA. While user authentication goes a long way to thwart fraudulent attacks, user authentication by itself is not sufficient to thwart all types of fraudulent attacks. In some types of attacks, a legitimate user provides correct credentials to log into a computer-based application but a fraudulent party breaks into the communication between the legitimate user and the computer-based application and fraudulently alters a transaction submitted by the legitimate user or submits an additional fraudulent transaction. Such an attack may be referred to as a Man-In-The-Middle-Attack (MITMA). A Man-In-The-Browser-Attack (MITBA, also known as MITB or MIB) is a particular example of a MITMA. In a MITBA, the user's client access device is infected by a piece of malware that is capable of manipulating what the browser displays to the user and/or what the browser sends to the webserver through the connection with that webserver (even if that connection itself is secured by means of a security mechanism such as the SSL/TLS protocol), without the user noticing. The malware could for example take the form of a proxy Trojan horse that infects the web browser and may be based on using common facilities to enhance browser capabilities such as Browser Helper Objects or browser extensions.

An existing solution that in theory provides a very high level of security works as follows. Instead of merely authenticating a user that logs into a computer-based application, the actual transaction purportedly submitted by that user is authenticated, i.e., it is ensured that a submitted transaction effectively originates from a legitimate user and is approved by that user and has not been altered since the user approved it. To authenticate a transaction, the user makes use of a separate electronic security apparatus to generate an electronic transaction over the transaction data. The transaction data that the computer-based application has received are provided to the electronic security apparatus. Thereafter, the electronic security apparatus presents the transaction data that it has received to the user. The electronic security apparatus may for example present the transaction data that it has received on its display. The user is then supposed to verify the correctness of the transaction data presented by the electronic security apparatus to ensure that what is being signed by the electronic security apparatus is really what the user has seen. If the user agrees with the transaction data presented by the electronic security apparatus, the user provides an approval of the presented transaction data to the electronic security apparatus. If the electronic security apparatus has thus received an approval of the presented transaction data from the user, the electronic security apparatus generates an electronic signature over these transaction data. The electronic signature generated by the electronic security apparatus is then transferred to an authentication server. The authentication server then verifies whether the electronic signature it has received is consistent with the transaction data that the computer-based application has. If the received electronic signature is not consistent with the transaction data that the computer-based application has, the electronic transaction may be rejected, otherwise it may be accepted.

A weak point in this solution is the assumption that the user will effectively verify the correctness of the transaction data presented by the electronic security apparatus. In reality, many users only too often approve the transaction data presented by the electronic security apparatus without effectively verifying the correctness of the transaction data presented by the electronic security apparatus, for example because they don't appreciate the importance of this step to the overall security or because out of complacency and their just wanting to move on with the transaction.

This weakness could be exploited by an attacker in, for example, the following way. The attacker could mount a MITMA attack whereby the transaction data that the user's client access device sends to the computer-based application are altered to the attacker's advantage (e.g., the attacker could change the destination account number of a money transfer into the number of an account controlled by the attacker) while ensuring that the transaction data that the user sees on their client access device remains the transaction data that the user entered and intended to submit to the computer-based application. For example, if the computer-based application is a web-based application that the user can access using a browser on the user's client access device then the attacker could mount a MITBA attack whereby a piece of malware on the user's client access device ensures that the transaction data that the user has entered in the browser is altered according to the attacker's plan when the browser sends the transaction data to the computer-based application, while the malware ensures that the browser continues to display the original transaction data entered by the user. The computer-based application thus receives a fraudulent set of transaction data that is different from the transaction data set intended by the user. The user's electronic security apparatus receives and presents to the user for verification and approval this fraudulent set of transaction data as received by the computer-based application. In principle, this allows the user detecting the attack. However, if the user in practice gives their approval without diligently performing the verification step, then the electronic security apparatus goes ahead with generating the electronic signature for the fraudulent set of transaction data. When the computer-based application subsequently receives the electronic signature generated by the user's electronic security apparatus, it will conclude that this electronic signature is consistent with the fraudulent set of transaction data that it has earlier received and it will accept this fraudulent set of transaction data.

What is needed is a solution for authenticating (electronic) transactions submitted to computer-based applications that doesn't rely on users diligently double-checking the transaction data presented to them by an electronic security apparatus.

### Technical Solution

A solution to the aforementioned problem is the invention described in the remainder of this description.

In one aspect of the invention, a computer based method is provided for authenticating an (electronic) transaction. In some embodiments, the method may comprise any of the methods described elsewhere in this description. In some embodiments, the method may be used with or performed by any of the systems and/or apparatus described elsewhere in this description.

In a first set of embodiments of the method, the method comprises the steps of:
causing a client access device to provide an output, by means of a user output interface of the client access device, to a user of the client access device wherein the output comprises a first representation of a first transaction data set, and wherein the first representation of the first transaction data set is in a format that is adapted to make it possible, and preferably also easy and convenient, for (ordinary) human users to decipher and understand the data of the represented first transaction data set (i.e., to make it possible for ordinary human users perceiving the output to retrieve the represented client transaction data);
capturing, by a client authentication device, from the user output interface of the client access device said output of the client access device;
by the client authentication device, generating or otherwise obtaining a transaction approval code that is linked to a second representation of the first transaction data set (such as for example an electronic signature over a representation of the extracted first transaction data set), and making, by the client authentication device, the generated or obtained transaction approval code available for transfer, for example, to an authentication server;
wherein the client authentication device uses said output captured by the client authentication device to perform the step of generating or otherwise obtaining the transaction approval code and making the generated or obtained transaction approval code available for transfer.

The method may be used to secure the interaction between the user and a computer-based application, whereby the client access device may be connected through a computer network to a computer system hosting the computer application and whereby the user uses the client access device to interact with the computer-based application. The method may for example be used to ensure that a server transaction data set that is known to, obtained by or received by a computer-based application server represents the same transaction that is also represented by a transaction data set (the client or first transaction data set) that is output to a user by the user's client access device and that the user may have entered and/or may have reviewed and approved. The method may be used to authenticate a transaction that is defined by the first data transaction set and that is submitted by the user to the computer-based application or presented by the computer-based application and that is approved by the user. The computer-based application may be adapted to accept and process a transaction authenticated by means of the method. The computer-based application with the computer system hosting that computer-based application may be referred to as the application server.

In the remainder of this description, the first transaction data set may also be referred to as the client transaction data set. Those components and/or parts of the application server that deal with certain security-related aspects of the computer application, such as performing a number of steps of the method, may be referred to as the authentication server. I.e., the authentication server is comprised in the application server. In practice, the authentication server may be provided and operated by a third party that is a trusted party to the computer-based application, i.e., performing the actions and functionality of the authentication server may in practice be delegated to a server of that trusted third party. In some embodiments, the authentication server may be the same as the application server. The output of the client access device that has been captured by the client authentication device from the user output interface of the client access device may be referred to shortly as the captured output.

Relation between an application transaction and the transaction data sets.

The transaction data sets discussed in this description are related to a transaction that the computer-based application should accept or reject. In some embodiments, the transaction data sets may be a full and complete representation of the transaction as defined and processed by the computer-based application. In other embodiments one or more of the transaction data sets may comprise only data elements corresponding to aspects of the transaction that are deemed relevant or sensitive from a security perspective, while these one or more transaction data sets may not necessarily comprise other data elements that correspond to other aspects of the transaction that are not deemed relevant, sensitive or crucial from a security perspective. For example, the computer-based application may comprise an internet banking application and a typical internet banking transaction may comprise a money transfer. Such a money transfer transaction may for example be defined by the source account number, the destination account number, the amount to be transferred, the currency, the date and time that the money should be transferred, and a description of the transfer. For simplicity, the transaction data sets used in an embodiment of the invention to secure such a transaction may only comprise those data elements that are deemed most interesting for an attacker to manipulate such as the destination account number, the amount to be transferred, and the currency. Similarly, some of the data elements of one or more of the transaction data sets may be less precise than the corresponding data elements of the application transaction that they are derived from. For example, in an internet banking transaction, the number defining the amount may have a fractional part (for example, it may be given up to a precision of 2 positions after the decimal separator, e.g., the amount of the internet banking transaction may specify not only the number of dollars or euros to transfer but also the number of dollar cents or euro cents), whereas the amount that is used in the corresponding transaction data sets used by an embodiment of the invention for securing the internet banking transaction may round or truncate the fractional part of the original amount. That means that in some embodiments it is possible in principle that multiple different application transactions may be correspond to or may be represented by the same client and/or server transaction data set, e.g., these multiple application transaction differ only in data elements that are deemed insufficiently security sensitive to be included in the client and/or server transaction data sets.

### Types of Representations of a Transaction Data Set.

Two different types of representations of a data set may be distinguished: content preserving representations and characterizing representations.

In content preserving representation of a data set, the various data elements of the data set are comprised in some specific format in the content preserving representation and it is in principle practically feasible to retrieve the values of these various data elements from the content preserving representation. For example, a content preserving presentation of a given data set may consist of a binary string consisting of a concatenated sequence of TLV encodings wherein each TLV encoding corresponds to one data element of the data set with the Tag field of the TLV encoding identifying the data element, the Length field indicating the length of the Value field and the Value field comprising the value of the data element. Another example of a content preserving representation of a data set may be a textual or alphanumerical description of the data set, provided that this textual or alphanumerical description (substantially) contains all the information of the data set and allows the reconstruction of the data set. Yet another example of a content preserving representation of a data set is an image or picture of such a textual or alphanumerical description, again provided that this image (substantially) contains all the information of the data set and allows the reconstruction of the data set. The aforementioned first representation of the client transaction data set is a content preserving representation of the client transaction data set.

In a characterizing representation, the characterizing representation is a function of the represented data set such that with a very high degree of probability two different data sets have two different characterizing representations. However, a characterizing representation does not comprise the various individual data elements of the data set and it may not be practically feasible to retrieve the values of these various data elements from the characterizing representation. A characterizing representation of a data set may for example comprise a message digest of the data set. A characterizing representation of a data set may for example comprise a cryptographic hash function (such as for example a SHA-1 hash) of a content preserving representation of the data set. The function to calculate a characterizing representation of a data set may comprise a cryptographic function that may be parameterized with a cryptographic key. A characterizing representation of a data set may for example comprise a MAC (Message Authentication Code) of a content preserving representation of the data set. A characterizing representation of a data set may for example comprise an electronic signature of the data set.

In this description, the terminology ‘representation of a data set’ by default (and unless otherwise specified or unless clear from the context) covers both types of representations.

The step of causing the client access device to provide an output, by means of a user output interface of the client access device, to the user of the client access device wherein the output comprises a representation of a first transaction data set (or client transaction data set), may be performed by the computer-based application. For example, in some embodiments a web server of the computer-based application may send a web page to the client access device that is displayed by a web browser on the client access device and that displays for example a textual representation of the client transaction data set.

The first representation of the client transaction data set is formatted and output by means of the user output of the client access device, such that it is possible, and preferably also easy and convenient, for (ordinary) human users (i.e., typical users of the computer-based application not having any specific specialized skills such as, for example, technical skills for decoding computer messages for machine-to-machine communication) to take knowledge (without undue effort) of the contents of the client transaction data set when perceiving the output of the user output interface of the client access device comprising the first representation of the client transaction data set; i.e., that it is possible, and preferably also easy and convenient, for (ordinary) human users to retrieve (without undue effort) the contents of the client transaction data set from the representation of the client transaction data set as it is output by the user output of the client access device and perceived by the user. In particular, the first representation of the client transaction data set is formatted and output in such a way that human users should on average not require the assistance of additional technical means to convert the first representation of the client transaction data set as it is comprised in the output of the user output interface of the client access device into some other representation format, to be able to take knowledge of the contents of the client transaction data set. I.e. the first representation of the client transaction data set is formatted in a format that is not designed to be processed and decoded essentially by machines only (such as for example the DTMF (dual-tone multi-frequency signaling) format or many types of 2D barcodes).

In some embodiments, the first transaction data set (or client transaction data set) presented by the client access device to the user, comprises the transaction data that defines a transaction that the user has submitted (or is submitting or intends to submit) to a computer-based application typically through the client access device (along with or followed by an explicit or implicit approval of the transaction). In other embodiments, the first transaction data set (or client transaction data set) presented by the client access device to the user, comprises the transaction data that defines a transaction that the computer-based application presents to the user and that the user is requested to approve.

Human readable analog output of the client access device.

In some embodiments the client access device's output to the user comprises an analog signal comprising a first representation of a first transaction data set (or client transaction data set), wherein the analog signal is suitable to be captured by the user's senses and wherein the first representation of the client transaction data set is in a human-readable format allowing human users (ordinary) human users to retrieve (without undue effort) the contents of the client transaction data set from this first representation of the client transaction data set. In some embodiments, this analog signal comprises or consists of a visual signal (i.e., a signal of emitted or reflected light in the visible part of the electromagnetic spectrum, i.e., electromagnetic radiation with a wavelength between 380 nm and 760 nm), the user output interface of the client access device may comprise a display of the user's client access device that outputs the visual signal, and the visual signal may comprise an image and the image may comprise a readable text comprising a set or series of words and/or numbers encoded by means of symbols such as characters of a writing system (e.g., an alphabet, such as the Latin, Cyrillic or Hangul alphabets, an abjad such as the Arabic or Hebrew abjad, a syllabary such as a Japanese kana syllabary, an abugida such as the North Indic or South Indic abugidas or Brahmic scripts, or a logographic writing system such as the Chinese Hanzi or the Japanese Kanji writing systems) and/or numerical digits (such as Arabic numerals), whereby the readable text defines or describes the first transaction data set (or client transaction data set), such as for example a web page with a textual representation of the transaction data that is displayed by a browser window on the display of the client access device. In some embodiments, the analog signal comprises or consists of an auditive signal (i.e., an acoustic signal in the audible frequency range, e.g., in the 20 to 20,000 hertz range), the user output interface of the client access device may comprise a sound system (such as a loudspeaker or headphones) of or attached to the user's client access device and that outputs the auditive signal, and the auditive signal or sounds emitted by this sound system may comprise recorded or synthesized speech comprising one or more words and/or sentences defining or describing the first transaction data set (or client transaction data set), such as a synthesized speech rendering of the transaction data output through the user's headphones connected to the client access device.

### User Approval.

In some embodiments, the client authentication device may, upon successfully performing the steps of capturing from the user output interface of the client access device the output of the client access device and (in some embodiments) extracting the first transaction data set (or client transaction data set) from the captured output, autonomously (i.e., without the client authentication device receiving from the user an indication of the user's approval) proceed to the step of generating or obtaining the transaction approval code and making it available for transfer, possibly after having first performed other additional steps such as for example comparing the extracted first transaction data set with another transaction data set (that the client authentication device may for example have received from an authentication server: see further) and establishing that the extracted first transaction data set and the other transaction data set are consistent. In other embodiments, the client authentication device may require an indication by the user of the user's approval (e.g., by the user pushing an OK button on the client authentication device) before performing or completing the step of generating or obtaining the transaction approval code and making it available for transfer. In some embodiments the client authentication device may present to the user the first transaction data set (or client transaction data set) that it has extracted from the captured output (for example by displaying the extracted first transaction set on a display of the client authentication device) and may request the user to approve the first transaction data set (or client transaction data set) that it presents to the user. If the user provides the approval then the client authentication device may proceed with performing or completing the step of generating or obtaining the transaction approval code and making it available for transfer; otherwise, if the user doesn't provide the approval or doesn't provide it in time, then the client authentication device may refrain from or may abort performing the step of generating or obtaining the transaction approval code and making it available for transfer.

### User Authentication.

In some embodiments, the client authentication device may be adapted to authenticate the user to ensure that the user operating the device is effectively the user that is associated with the client authentication device (and that is authorized to use the client authentication device). In some embodiments, the client authentication device may receive from the user a password (such as a PIN) by means of a user input interface of the client authentication device, and may authenticate the user by comparing the received password with a reference representation of the expected password that may be stored in the client authentication device. In other embodiments, the client authentication device may capture a biometric measurement of the user (such as a fingerprint of the user or a picture of the user's face) and may authenticate the user by comparing the captured biometric measurement with a biometric template of the user associated with the client authentication device, whereby this biometric template may be stored in the client authentication device. In some embodiments, the client authentication device performs or completes the step of generating or obtaining the transaction approval code and making it available for transfer only after first having successfully performed the step of authenticating the user. In some embodiments, the user performing the actions necessary for authenticating the user (such as providing a password or a fingerprint) may be considered as an implicit indication of the user's approval for the client authentication device to go ahead with performing or completing the step of generating or obtaining the transaction approval code and making it available for transfer.

### Security Requirements for the Transaction Approval Code.

The transaction approval code should be securely linked to the client transaction data set. Only one or a small number of particular transaction approval code values should be valid for any given set of transaction data at any given time. The transaction approval codes linked to two different transaction data sets (i.e., transaction data sets that are not equivalent) should with a high probability also be different. It should not be practically feasible for an attacker to obtain a valid transaction approval code value for a transaction data set of the attacker's choice without access to the user's client authentication device. As a minimum, it should be highly unlikely to obtain a valid transaction approval code value for a given transaction data set by randomly guessing.

### Personalized Client Authentication Devices.

In typical embodiments, the user is one of a plurality of users and the client authentication device is one of a plurality of client authentication devices, whereby with each user of the plurality of users at least one of the plurality of client authentication devices is associated, and whereby each one of the plurality of client authentication devices is characterized by a set of one or more device characterizing data items, whereby the device characterizing data items of each client authentication device associated with a user of the plurality of users have been given values that are practically unique with respect to the values of the device characterizing data items of the client authentication devices associated with the other users of the plurality of users. In such embodiments, the step of the client authentication device generating or otherwise obtaining a transaction approval code that is linked to the extracted first transaction data set typically comprises using one or more of the device characterizing data items of the client authentication device in the generation of the transaction approval code. In some embodiments, the device characterizing data items of a client authentication device may for example comprise a secret cryptographic key that may be used by the client authentication device when generating the transaction approval code using a cryptographic function that is parameterized with that secret cryptographic key. In other embodiments, the device characterizing data items of a client authentication device may for example comprise an address (such as a network address, an IP address or a telephone address) of a the client authentication device when the client authentication device is an end-point of a communication link between a server such as an authentication sever of computer-application server and the address may be used by the client authentication device for example to obtain the transaction approval code by receiving the transaction approval code over this communication link.

In the remainder of this description, the terminology ‘personalizing a client authentication device’ or ‘personalizing the device characterizing data items of a client authentication device’ may be used to refer to the step of providing practically unique values to the device characterizing data items of that client authentication device. The set of device characterizing data items of a client authentication device is typically stored in that client authentication device.

In some embodiments more than one client authentication device may be associated with the same user. In some embodiments, the device characterizing data items of each client authentication device associated with a user of the plurality of users have been given values that are practically unique with respect to the values of the device characterizing data items of other client authentication devices associated with any user of the plurality of users (including with respect to the values of the device characterizing data items of other client authentication devices associated with the same user). In other embodiments, the device characterizing data items of a client authentication device associated with a user of the plurality of users may have been given values that are the same as the values that have been given to the device characterizing data items of another client authentication device that is associated with the same user.

In this context, the terminology that a device characterizing data item of a particular client authentication device has been given a value that is practically unique with respect to the value of the corresponding device characterizing data items of the client authentication devices of a reference set of client authentication devices, means that in some embodiments it is very improbable that there is any client authentication device of the reference set with a corresponding device characterizing data item that has the same value as the value of the device characterizing data item of the particular client authentication device. For example, in some embodiments the device characterizing data item may be a secret cryptographic key that is randomly generated (and independently of the generation of the secret cryptographic keys of the other client authentication devices) whereby the search space for that secret cryptographic key (i.e., the number of all different values that can be generated for this secret cryptographic key) may be many orders of magnitude larger than the number of client authentication devices in the reference set. Since the values for the secret cryptographic key of two different client authentication devices are generated randomly and independently of each other, it can theoretically not be excluded that by coincidence the same value is generated for these two different client authentication devices, however this is very improbably because of the size of the search space of the secret cryptographic key. In other embodiments, it means that the value of the device characterizing data items of a particular client authentication device are unique in a strict sense, i.e., for any particular client authentication device there is no other client authentication device in the reference set of client authentication devices with device characterizing data items that have the same values as the values of the device characterizing data items of the particular client authentication device. For example, in some embodiments the device characterizing data item may be a serial number that is generated in such a way that it is unique for each different client authentication device, or it may be a secret cryptographic key that is generated by encrypting such a serial number with a secret master key.

### Server Verification of the Transaction Approval Code.

In some embodiments of the method, the method may comprise any set of the first set of embodiments further comprising the steps of:
receiving, by an authentication server, the transaction approval code that was generated or obtained and made available for transfer by the client authentication device;
verifying, by the authentication server, whether the received transaction approval code is consistent with a second transaction data set known to the authentication server; and
generating, by the authentication server, an approval signal for the second transaction data set in case that said verifying whether the received transaction approval code is consistent with the second transaction data set indicates that the received transaction approval code is indeed consistent with the second transaction data set.

In the rest of this description, the second transaction data set known to the authentication server may also be referred to as the server transaction data set.

In a second set of embodiments of the method, the method may comprise any method of the first set of embodiments further comprising the steps of:
receiving or obtaining, by the authentication server, a server transaction data set;
receiving, by the authentication server, the transaction approval code that the client authentication device has generated or obtained and made available for transfer to the authentication server;
verifying, by the authentication server, whether the received transaction approval code matches the received or obtained server transaction data set;

In a third set of embodiments of the method, the method may comprise any method of the second set of embodiments further comprising the steps of:
generating, by the authentication server, an approval signal for the server transaction data set if (i.e., on condition that) the authentication server's verifying whether the received transaction approval code matches the received or obtained server transaction data set results in the authentication server finding that the received transaction approval code indeed matches the received or obtained server transaction data set.

The second transaction data set (or server transaction data set) typically comprises or is equivalent to the transaction data as received by the authentication server from the client access device or known to the authentication server and sent to the client access device for the user's approval. If all goes well, the second transaction data set (or server transaction data set) and the first transaction data set (or client transaction data set) should define the same transaction (i.e., the second transaction data set and the first transaction data set should be identical or at least be equivalent representations of the same transaction).

In the case that the transaction approval code comprises for example an electronic signature (see further for more details) that has been generated by the client authentication device over the first transaction data set (or client transaction data set), an inconsistency between that electronic signature as received by the authentication server and the second transaction data set (or server transaction data set) is likely due to an inconsistency between the first transaction data set (or client transaction data set) and the second transaction data set (or server transaction data set). A MITMA attack would typically cause the first transaction data set (or client transaction data set) that the client access device outputs to the user (and that is captured by the client authentication device) to be different from the second transaction data set (or server transaction data set) that is received or known to the authentication server. An inconsistency between that electronic signature as received by the authentication server and the second transaction data set (or server transaction data set) would therefore be an indication of a possible MITMA attack, even though there could also be other causes for such an inconsistency, such as for example transmission errors when transferring the electronic signature from the client authentication device to the authentication server or transmission errors when the client authentication device captures the output from the user output interface of the client access device.

### Approval Signal for the Server Transaction Data Set.

The approval signal indicates that the authentication server has found that the received transaction approval code indeed matches the received or obtained server transaction data set. In some embodiments, the authentication server generating an approval signal for the server transaction data set may be a necessary condition for the computer-based application to accept the transaction corresponding to the server transaction data set. In some embodiments, the authentication server generating an approval signal for the server transaction data set may also be a sufficient condition for the computer-based application to accept the transaction corresponding to the server transaction data set. In other embodiments, the authentication server generating an approval signal for the server transaction data set may be one factor among a set of factors that the computer-based application may take into account in deciding whether to accept the transaction corresponding to the server transaction data set. While a finding by the authentication server that the received transaction approval code indeed matches the received or obtained server transaction data set indicates that there is a very high probability that the transaction corresponding to the server transaction data set is also the transaction that corresponds to the transaction corresponding to the representation of the client transaction data set that the client access device has presented to the user in its output to the user, this cannot be guaranteed with absolute certainty in all circumstances. For example, in some cases it cannot be guaranteed with absolute certainty that an attacker cannot get access and control over the client authentication device, or that one or more cryptographic keys that are used by the client authentication device and/or the authentication server may be compromised, or that an attacker by pure coincidence may obtain by lucky guessing a valid transaction approval code for a fraudulent transaction data set. In some embodiments, a computer-based application may therefore in some circumstances (for example on the basis of a risk assessment taking into account additional conditions and information) decide to reject a transaction corresponding to the server transaction data set even if the authentication server has generated the approval signal for the server transaction data set.

### Original Source of the Transaction Data.

Server receiving the transaction from the client access device. In some embodiments, the authentication server may receive the server transaction data set from the client access device. For example, the user may enter a transaction on the client access device (for example, by using a web form for submitting transactions that the computer-based application has sent to a browser on the client authentication device) and the client access device may send the corresponding transaction data set to a server of the computer-based application upon which the received transaction data set (which is now the server transaction data set) may then be passed to the authentication server.

Server receiving the transaction from the client authentication device. In some embodiments, the authentication server may receive the server transaction set from the client authentication device. For example, the user may enter a transaction on the client access device which then may output a set of data representing this transaction (i.e., the first transaction data set or client transaction data set) to the user, and after the client authentication device has captured this output of the client access device, the client authentication device may use said output captured by the client authentication device to generate said second representation of the first transaction data set as a function of said output captured by the client authentication device, and the client authentication device may send both the transaction approval code and the generated second representation of the first transaction data set to the authentication server. The authentication server may then receive the transaction approval code and the second representation of the first transaction data set generated by the client authentication device and may take the received second representation of the first transaction data set as its server transaction data set and may approve this transaction data set received from the client authentication device after having verified whether the received transaction approval code matches the received transaction data set.

Server obtaining the transaction from another source. In some embodiments, the authentication server may obtain the server transaction set from a source that is neither the client access device nor the client authentication device. For example, in some embodiments the computer-based application may receive a transaction proposal form a third party. The computer-based application may then submit a transaction data set representing this proposed transaction to the user's client access device and the user's client access device may then output the transaction data set that it received from the computer-based application to the user for review and approval.

Extraction of the client transaction data from the captured output and use of the extracted client transaction data.

In some embodiments, a representation of the client transaction data is extracted from the captured output (i.e., the output of the client access device that has been captured by the client authentication device from the user output interface of the client access device) and compared to a representation of the server transaction data set.

In some embodiments, the client authentication device extracts a representation of the client transaction data from the captured output, receives a representation of the server transaction data, and compares the extracted representation of the client transaction data with the received representation of the server transaction data to verify whether the extracted representation of the client transaction data matches the received representation of the server transaction data set. If the client authentication device finds that the extracted representation of the client transaction data doesn't match the received representation of the server transaction data set, the client authentication device may not perform, or may not complete, the step of generating or otherwise obtaining a transaction approval code that is linked to a second representation of the first transaction data set and making the generated or obtained transaction approval code available for transfer. Otherwise, the client authentication device may perform the step of generating or otherwise obtaining a transaction approval code that is linked to a second representation of the first transaction data set and making the generated or obtained transaction approval code available for transfer. In some embodiments, the step of generating or otherwise obtaining the transaction approval code may comprise the client authentication device generating the transaction approval code as an electronic signature of a representation of the extracted client transaction data. In other embodiments, the step of generating or otherwise obtaining the transaction approval code may comprise the client authentication device generating the transaction approval code as a function of a server transaction reference code that the client authentication device has received linked to the received server transaction data set (see further for details).

In some embodiments, the authentication server obtains a representation of the client transaction data extracted from the captured output.

In some embodiments, the client authentication device extracts a representation of the client transaction data from the captured output and the authentication server obtains this representation of the client transaction data extracted by the client authentication device from the captured output by receiving it from the client authentication device. In other embodiments, the client authentication device generates a (digital) representation of the captured output and the authentication server obtains a representation of the client transaction data extracted from the captured output by receiving this (digital) representation of the captured output and extracting a representation of the client transaction data from this (digital) representation of the captured output.

In some embodiments, the authentication server adopts the obtained representation of the client transaction data extracted from the captured output as its server transaction data set. In such embodiments, the representation of the client transaction data extracted from the captured output by the client authentication device and obtained by the authentication server may preferably be a content preserving representation of the client transaction data. In other embodiments, the authentication server compares the obtained representation of the client transaction data with a server transaction data set, for example as part of the step of verifying, by the authentication server, whether the received transaction approval code is consistent with the server transaction data set.

### First Group of Embodiments

In a first group of embodiments of the method, the client authentication device may receive a representation of the server transaction data set and compare the received server transaction data set to the client transaction data in the captured output. The client authentication device may generate (or obtain) the transaction approval code and make the transaction approval code available for transfer only if this comparison results in a finding that the received server transaction data set matches the client transaction data in the captured output.

In some embodiments of the method, the method may comprise any set of the first, second or third sets of embodiments further comprising the steps of:
extracting, by the client authentication device, said first transaction data set from said captured output;
receiving, by the client authentication device, a machine readable message comprising a representation of a third transaction data set;
extracting, by the client authentication device, the representation of the third transaction data set from the received machine readable message; and
verifying, by the client authentication device, whether the extracted representation of the third transaction data set and the extracted first transaction data set define the same transaction.

The third transaction data set comprises or is equivalent to the transaction data as received by the authentication server from the client access device or known to the authentication server and sent to the client access device for the user's approval. In embodiments of the method that comprise an embodiment of the second set of embodiments of the method, the third transaction data set is identical or equivalent to the second transaction data set (or server transaction data set). In some embodiments the third transaction data set is the server transaction data set.

In a fourth set of embodiments of the method, the method may comprise any method of the second or third sets of embodiments further comprising the steps of:
extracting, by the client authentication device, the client transaction data set from said captured output;
receiving, by the client authentication device, a representation of the server transaction data set; and
verifying, by the client authentication device, whether the received representation of the server transaction data set matches the extracted client transaction data set.

In some embodiments, the step of the client authentication device receiving a representation of the server transaction data set happens after the step of the authentication server receiving or obtaining the server transaction data set. In some embodiments, the authentication server first receives or obtains a server transaction data set, and then a representation of the server transaction data set received or obtained by the authentication server is generated (e.g., by the authentication server), whereafter the generated representation of the server transaction data set is sent to the client authentication device (and received by the client authentication device) for example comprised in a machine readable message that the client authentication device may receive and from which the client authentication device may then extract the representation of the server transaction data set.

In a fifth set of embodiments of the method, the method may comprise any method of the fourth set of embodiments, wherein the step of the client authentication device receiving a representation of the server transaction data set may comprise:
receiving, by the client authentication device, a machine readable message comprising the representation of the server transaction data set; and
extracting, by the client authentication device, the representation of the server transaction data set from the received machine readable message.

### Example: Machine Readable Message is a 2D Barcode

For example, in some embodiments the machine readable message may be in the form of a 2D barcode that may be displayed by the client access device on a display of the client access device. The client authentication device may capture, for example by means of a camera comprised in the client authentication device, one or more images of the 2D barcode being displayed by the client access device and the client authentication device may extract the 2D barcode from the captured one or more images. The client access device may also display a human-readable textual representation of the client transaction data set, for example on the same display that it also uses to display the 2D barcode. In some embodiments, the 2D barcode may be displayed together and along with a human-readable textual representation of the client transaction data set. For example, the client access device may display a web page that contains next to each other the 2D barcode and the human-readable textual representation of the client transaction data set. In such embodiments, the client authentication device may capture a single image, for example by means of a camera comprised in the client authentication device, of what the client access device is displaying (which comprises the 2D barcode and the human-readable textual representation of the client transaction data set) and may extract from that image both the 2D barcode and the textual representation. In other embodiments, the client access device may display the 2D barcode and the human-readable textual representation of the client transaction data set separately and/or at different times. In some embodiments, the client authentication device may capture a first image, for example by means of a camera comprised in the client authentication device, of the 2D barcode being displayed by the client access device and may extract the 2D barcode from that first captured image, and the client authentication device may capture a second image of the human-readable textual representation of the client transaction data set and may extract the human-readable textual representation of the first transaction data set from that second captured image. After the client authentication device has captured and extracted the 2D barcode, the client authentication device may decode the captured and extracted 2D barcode to extract, e.g., the representation of the server transaction data set. The client authentication device may furthermore extract the client transaction data set from the textual representation.

In some embodiments the machine readable message may be transferred to the client authentication device in one single part. In other embodiments it may be transferred to the client authentication device in multiple separate parts.

In some embodiments the method may comprise the step of the authentication server generating the machine readable message. To avoid that the attacker may alter the contents of the message for example to replace the representation of the server transaction data set (or third transaction data set) in the message with a representation of another data set (more specifically with a representation of the attacker's fraudulent data set), in some embodiments cryptographic mechanisms to protect the data integrity of the machine readable message may be used. For example, in some embodiments, the machine readable message is cryptographically protected for authenticating the machine readable message as coming from the authentication server and the method may comprise the step of authenticating, by the client authentication device, the machine readable message as coming from the authentication server. For example, the machine readable message may be encrypted by the authentication server and/or a MAC (Message Authentication Code) or an electronic signature may be added by the authentication server to the message, and the client authentication device may decrypt the machine readable message and/or verify the validity of the MAC or the electronic signature to authenticate the machine readable message as coming from the authentication server. In embodiments whereby the machine readable message is encrypted by the authentication server and decrypted by the client authentication device, the machine readable message may be encoded in such a manner that the machine readable message's contents have some redundancy. For example, the machine readable message may comprise a CRC (Cyclic Redundancy Check) or a check digit over (some of) the rest of the contents of the machine readable message. To authenticate the machine readable message as coming from the authentication server, the client authentication device may verify that this redundancy is indeed correctly present in the decrypted machine readable message. Any change to the encrypted machine readable message is likely to result in an inconsistency that breaks the redundancy that the client authentication device expects to be present. If the client authentication device verifies that this redundancy is not (correctly) present in the decrypted machine readable message, then the client authentication device may conclude that the encrypted machine readable message may have been altered or may have been tampered. In some embodiments, the client authentication device may refuse the machine readable message and abort the transaction authentication process if the machine readable message cannot successfully be authenticated as coming from the authentication server and/or if the contents of the machine readable message appear to have been altered or tampered with. In some embodiments, if the client authentication device cannot authenticate the machine readable message as coming from the authentication server and/or it cannot confirm that the contents of the machine readable message have not changed, then the client authentication device does not perform or complete the step of generating or obtaining the transaction approval code and making it available for transfer.

Verifying whether the received representation of the server transaction data set matches the extracted client transaction data set.

In some embodiments, the received representation of the server transaction data set may be a content preserving representation, and the step of the client authentication device verifying whether the received representation of the server transaction data set matches the extracted client transaction data set may comprise the client authentication device verifying whether the received representation of the server transaction data set and the extracted client transaction data set define the same transaction or whether the received representation of the server transaction data set and the extracted client transaction data set are equivalent.

In other embodiments, the received representation of the server transaction data may comprise a first message digest of the server transaction data set, and the step of the client authentication device verifying whether the received representation of the server transaction data set matches the extracted client transaction data set may comprise the client authentication device generating a second message digest of the extracted client transaction data set and verifying whether the received first message digest of the server transaction data set matches the generated second message digest of the extracted client transaction data set (e.g., by verifying whether the first message digest and the second message digest are identical or equivalent).

In some embodiments, the received or extracted representation of the server transaction data set may comprise or may consist of a first message digest of the server transaction data set that is characteristic or specific for a particular server transaction data set (i.e., if a change is made to the server transaction data set then the probability is very high that the corresponding message digest will also change) but from which it is practically infeasible to determine the actual server transaction data. In some embodiments the first message digest may be generated as a (cryptographic) one-way function of the server transaction data set. For example, in some embodiments the (cryptographic) one-way function may be a cryptographic hash function such as for example one of the SHA-3 (Secure Hashing Algorithms) cryptographic hash functions. In some embodiments, the step of verifying, by the client authentication device, whether the extracted or received representation of the server transaction data set matches (e.g., defines the same transaction as) the extracted client transaction data set may comprise the steps of the client authentication device generating a second message digest of a representation of the extracted client transaction data and verifying whether this second message digest matches the first message digest comprised in the extracted or received representation of the server transaction data set. The message digest may be the result of applying (by the authentication server) the cryptographic one-way (e.g., hash) function on the server transaction data set represented in a particular format; and the step of verifying, by the client authentication device, whether the extracted or received representation of the server transaction data set matches the extracted client transaction data set may comprise the steps of the client authentication device generating a second message digest as the result of applying the same cryptographic one-way (e.g., hash) function to the extracted client transaction data represented in said particular format and then verifying whether this second message digest matches the first message digest comprised in the extracted or received representation of the server transaction data set. In some embodiments, the cryptographic one-way function may be parameterized by a secret cryptographic key. For example, the cryptographic one-way function may comprise the HMAC (keyed-Hash Message Authentication code or Hash-based Message Authentication Code) function. In some embodiments this secret cryptographic key may be shared by the authentication server and the client authentication device.

Representation of the server transaction data set comprises an electronic signature.

In some embodiments, the representation of the server transaction data set may comprise or may consist of a server electronic signature that has been generated by the authentication server over the server transaction data set; and the step of verifying, by the client authentication device, whether the extracted or received representation of the server transaction data set and the extracted client transaction data set define the same transaction, may comprise the step of the client authentication device verifying the server electronic signature, i.e., whether the server electronic signature is consistent with the extracted client transaction data set.

### Consequence of Result of the Verification.

In a sixth set of embodiments, the method may comprise any method of the fourth or fifth set of embodiments wherein the step of generating or otherwise obtaining a transaction approval code that is linked to a second representation of the client (or first) transaction data set and making the generated or obtained transaction approval code available for transfer is performed or completed by the client authentication device only if the step of verifying, by the client authentication device, whether the received representation of the server transaction data set matches the extracted client transaction data set, results in the client authentication device finding that the received representation of the server transaction data set indeed does match the extracted client transaction data set.

For example, in some embodiments, the step of generating or obtaining the transaction approval code and making it available for transfer is performed or completed by the client authentication device only if the step of verifying by the client authentication device whether the extracted third transaction data set (or server transaction data set) and the extracted first transaction data set (or client transaction data set) define the same transaction, leads to the conclusion that the extracted representation of the third transaction data set (or server transaction data set) and the extracted first transaction data set (or client transaction data set) indeed define the same transaction.

### Consequence of Detecting a Mismatch.

In some embodiments, if upon performing the step of verifying whether the received representation of the server transaction data set matches the extracted client transaction data set, the client authentication device finds that the received representation of the server transaction data set does not match the extracted client transaction data set, then the client authentication device does not perform or does not complete the step of generating or otherwise obtaining a transaction approval code that is linked to a second representation of the first transaction data set and making the generated or obtained transaction approval code available for transfer.

For example, if upon performing the step of verifying whether the extracted representation of the third transaction data set (or server transaction data set) and the extracted first transaction data set (or client transaction data set) define the same transaction, the client authentication device concludes that the extracted third transaction data set (or server transaction data set) and the extracted first transaction data (or client transaction data set) don't match (i.e., that they don't seem to define the same transaction), the client authentication device may in some embodiments abort the authentication process and not does not perform or complete the step of generating or obtaining the transaction approval code and making it available for transfer.

In some embodiments, the client authentication device may upon detecting a mismatch between the received representation of the server transaction data set (e.g., the extracted third transaction data set) and the extracted client transaction data set (or first transaction data set) inform the user of the detection of the mismatch. In some embodiments the client authentication device may provide details about the mismatch to the user, for example by showing to the user where exactly the received representation of the server transaction data set (e.g., the extracted third transaction data set) and the extracted client transaction data set (or first transaction data set) differ. This may help the user to determine whether there is genuinely a mismatch between the server (or third) transaction data set (which represents the transaction as received by or known to the computer-based application) and the client (or first) transaction data set that the user observes on the output of the client access device (and that represents the transaction as known to the user), or whether there is rather a mismatch between the client (or first) transaction data set as output by the client access device and the client (or first) transaction data set as extracted by the client authentication device from the client access device's output that has been captured by the client authentication device.

### First Subgroup of the First Group of Embodiments

In a first subgroup of embodiments of the first group of embodiments of the method, the client authentication device may also (in addition to receiving the representation of the server data transaction data set) receive a server transaction reference code and generate the transaction approval code as a function of the server transaction reference code, wherein the server transaction reference code has been generated by the authentication server and has been linked by the authentication server to the server transaction data set.

For example, in some embodiments, the transaction approval code may be originally generated by the authentication server and subsequently communicated to the client authentication device. For example, the transaction approval code may be included by the authentication server in a machine readable message that comprises the representation of the server transaction data set and that is transferred to the authentication client device, and the transaction approval code may subsequently be extracted by the client authentication device from the machine readable message that the client authentication device has received.

To minimize the probability that an attacker can obtain a valid transaction approval code for a fraudulent transaction data set, the method that the server uses to generate the transaction approval code or the server transaction reference code should be preferably such that it is practically infeasible for the attacker to duplicate this method. From the perspective of an attacker, the value of the transaction approval code or the server transaction reference code that the server generates for a particular transaction data set should be unpredictable.

In some embodiments the authentication server may generate the transaction approval code or the server transaction reference code in an unpredictable way as a function of a random data element, For example, the authentication server may generate the transaction approval code or the server transaction reference code as the result of a (true) random number generator.

In other embodiments, the authentication server may generate the transaction approval code or the server transaction reference code as a function of the server transaction data set known to the server. In some embodiments, this function may be deterministic. To make the result of this function unpredictable, the function may comprise or use a secret element. For example, the server may generate the transaction approval code or the server transaction reference code as a function of a secret data element and the server transaction data set known to the server. For example, the server may generate the transaction approval code or the server transaction reference code as a cryptographic one-way function of the server transaction data set known to the server whereby the cryptographic one-way function is parameterized with the secret data element.

In a seventh set of embodiments, the method may comprise any method of the sixth set of embodiments, further comprising the steps of:
the authentication server generating a server transaction reference code and linking the generated server transaction reference code to the server transaction data set; and
the client authentication device receiving the server transaction reference code;
wherein the step of the client authentication device generating or otherwise obtaining the transaction approval code that is linked to a second representation of the client transaction data set comprises the client authentication device generating the transaction approval code as a function of the server transaction reference code

For example, in some embodiments the authentication server has obtained or received a server transaction data set, for example either from the client access device or from another source that is neither the client access device nor the client authentication device. The authentication server may then generate a server transaction reference code and associate that server transaction reference code with the server transaction data set.

### Generation of the Server Transaction Reference Code.

In some embodiments, the server transaction reference code should be generated in such a way that its value is not predictable by an attacker.

In some embodiments, the authentication server may generate the server transaction reference code as a cryptographic function of the server transaction data set wherein the cryptographic function is parameterised by a secret data element (which may be referred to as the secret server transaction reference code generation key), whereby it may be assumed that it is practically not feasible for an attacker to obtain or guess the value of the secret server transaction reference code generation key. In some embodiments, the resulting server transaction reference code may be fully defined by the server transaction data set and the secret server transaction reference code generation key, such that the server transaction reference code generated in this way is automatically and intrinsically linked to the server transaction data set.

In some embodiments, the authentication server may generate the server transaction reference code by generating a data element that may further be referred to as a transaction reference code seed and that the authentication server may store in association with the server transaction set for later retrieval and usage (for example to re-generate a corresponding server transaction reference code when verifying a received transaction approval code). In some embodiments, the authentication server may generate the transaction reference code seed as a value that is (practically) unique for the server transaction data set that it is associated with.

In some embodiments, the authentication server may generate the server transaction reference code as a cryptographic function of the transaction reference code seed wherein the cryptographic function is parameterised by a secret server transaction reference code generation key, whereby it may be assumed that it is practically not feasible for an attacker to obtain or guess the value of the secret server transaction reference code generation key. In some embodiments, the authentication server may generate the server transaction reference code as an electronic signature of the transaction reference code seed. In some embodiments, the authentication server may generate the server transaction reference code by encrypting the transaction reference code seed.

In some embodiments, the authentication server may generate the transaction reference code seed as a random value and may generate the server transaction reference code as a function of the transaction reference code seed. In some embodiments, this function to generate the server transaction reference code from the transaction reference code seed may be a trivial function. For example, in some embodiments, the authentication server may set the value of the server transaction reference code to the value of the transaction reference code seed.

In an eighth set of embodiments, the method may comprise any method of the seventh set of embodiments, wherein the step of the authentication server generating a server transaction reference code and linking the generated server transaction reference code to the server transaction data set may comprise the authentication server generating the server transaction reference code as a cryptographic function of the server transaction data set wherein the cryptographic function is parameterized by a secret server transaction reference code generation key.

In an ninth set of embodiments, the method may comprise any method of the seventh set of embodiments, wherein the step of the authentication server generating a server transaction reference code and linking the generated server transaction reference code to the server transaction data set may comprise the authentication server generating a transaction reference code seed and storing the generated transaction reference code in association with the server transaction set.

In an tenth set of embodiments, the method may comprise any method of the ninth set of embodiments, wherein the authentication server may generate the server transaction reference code as a cryptographic function of the transaction reference code seed wherein the cryptographic function is parameterized by a secret server transaction reference code generation key.

In an eleventh set of embodiments, the method may comprise any method of the ninth set of embodiments, wherein the authentication server may generate the transaction reference code seed as a random value and may generate the server transaction reference code as a function of the transaction reference code seed.

In a twelfth set of embodiments, the method may comprise any method of the eleventh set of embodiments, wherein the authentication server generates the server transaction reference code by setting the value of the server transaction reference code to the value of the transaction reference code seed.

Transfer of the server transaction reference code to the client authentication device.

This server transaction reference code may then be sent to the client authentication device along with a representation of the server transaction data set. The server transaction reference code and the representation of the server transaction data set should be sent to the client authentication device in such a way that the server transaction reference code that the client authentication code receives is linked to the representation of the server transaction data set that the client authentication code receives and such that it is practically infeasible for an attacker to interfere with the transfer such that the attacker may successfully substitute the representation of the server transaction data set with a representation of another transaction data set. In some embodiments, the server transaction reference code is sent to the client authentication device in such a way that it is practically infeasible for an attacker to interfere with the transfer such that the attacker may obtain the value of the transaction reference code. For example, in some embodiments the server transaction reference code and the representation of the server transaction data set may be sent to the client authentication device using an out-of-band transfer mechanism with respect to the mechanism used for the communication between the client access device and the computer-application server. Preferably, a physically separate channel may be used for the out-of-band transfer of the server transaction reference code to the client authentication device. Or, the server transaction reference code that the client authentication device receives may be cryptographically linked to the representation of the server transaction data set that the client authentication device receives and the client authentication device may verify this cryptographic link. For example, in some embodiments cryptographic mechanisms may be used to protect the integrity of the server transaction data set and the link of the server transaction data set with the server transaction reference code and/or to protect the confidentiality of the server transaction reference code. For example, in some embodiments a message comprising the representation of the server transaction data set and/or the server transaction reference code may be encrypted by the authentication server before being sent to the client authentication device and may then be decrypted by the client authentication device after having been received by the client authentication device; and/or such a message may comprise an electronic signature or authentication code (such as a MAC) to authenticate the source of the server transaction data set and/or the server transaction reference code as effectively being the authentication server and the client authentication device may verify this electronic signature or authentication code.

In a thirteenth set of embodiments, the method may comprise any method of the seventh to twelfth sets of embodiments, wherein the server transaction reference code that the client authentication device receives is linked to the representation of the server transaction data set that the client authentication device receives.

In a fourteenth set of embodiments, the method may comprise any method of the thirteenth set of embodiments, wherein the server transaction reference code that the client authentication device receives is cryptographically linked to the representation of the server transaction data set that the client authentication device receives.

Comparison of the received server transaction data set with the client transaction data set in the captured output.

The client authentication device may then verify whether the received server transaction data set is equivalent to the client transaction data set (i.e., the first transaction data set) in the output that it has captured from the user output interface of the client access device. The client authentication device may extract a (second) representation of the client transaction data set from the captured output and compare this extracted second representation of the client transaction data with the received server transaction data. If the client authentication device then finds that the received server transaction data set indeed is equivalent to the client transaction data set in the output that the client authentication device has captured from the user output interface of the client access device, then the client authentication device may generate the transaction approval code and may make this transaction approval code available for transfer to the authentication server. However, if the client authentication device finds that the received server transaction data set is not equivalent to the client transaction data set in the output that the client authentication device has captured from the user output interface of the client access device, then the client authentication device may not generate the transaction approval code, or it may generate the transaction approval code but not make the generated transaction approval code available for transfer to the authentication server.

### Generating the Transaction Approval Code.

In a fifteenth set of embodiments, the method may comprise any method of the seventh to fourteenth sets of embodiments, wherein the client authentication device may generate the transaction approval code as a function of the received server transaction reference code. For example, in a sixteenth set of embodiments, the method may comprise any method of the fifteenth set of embodiments, wherein the client authentication device may generate the transaction approval code as simply being identical to the received server transaction reference code, or, in a seventeenth set of embodiments, the method may comprise any method of the fifteenth set of embodiments, wherein the client authentication device may generate the transaction approval code as a cryptographic function of the received server transaction reference code. This cryptographic function may be parameterized by a secret key that may be stored in or that may be accessible by the client authentication device. For example, in some embodiments the client authentication device may generate the transaction approval code as an electronic signature (such as a MAC) over the received server transaction reference code.

Link between the transaction approval code and the client transaction data set.

The transaction approval code that is made available for transfer has been generated by the client authentication device as a function of the received server transaction reference code. the received server transaction reference code is associated with the server transaction data set, and the server transaction data set is represented by the received representation of the server transaction data set. In other words, the transaction approval code that is made available for transfer is linked to the received representation of the server transaction data set. The transaction approval code is furthermore generated or otherwise obtained and made available for transfer by the client authentication device only if the client authentication device has found that the received representation of the server transaction data set does indeed match the extracted client transaction data set. In other words, if the client authentication device makes an transaction approval code available for transfer then this means that the received representation of the server transaction data set, and hence also the server transaction data set itself, matches the extracted client transaction data set. It follows that the transaction approval code that is made available for transfer is effectively linked to a representation of the client transaction data set (namely the extracted client transaction data set). In other words, the second representation of the client (i.e., first) transaction data set that the transaction approval code is linked to, is the extracted client transaction data set.

The authentication server verifying the transaction approval code.

The generated transaction approval code may then be transferred to the authentication server. For example, in some embodiments the client authentication device may itself send the generated transaction approval code to the authentication server. In other embodiments, the client authentication device may make the generated transaction approval code available to the user for transfer, whereby the user may cause the generated transaction approval code to be further forwarded to the authentication server. For example, in some embodiments the client authentication device may display the generated transaction approval code, for example as an alphanumerical string, on a display of the client authentication device, and the user may read the displayed transaction approval code and provide it to the client access device which in turn may send the transaction approval code to the authentication server. After having received the transaction approval code, the authentication server may verify the received transaction approval code.

In an eighteenth set of embodiments, the method may comprise any method of the seventh to seventeenth sets of embodiments, wherein the authentication server may perform the step of verifying whether the received transaction approval code matches the server transaction data set by retrieving or re-generating the server transaction reference code that is linked to the server transaction data set and verifying whether the received transaction approval code matches the retrieved or re-generated transaction reference code.

### Second Subgroup of the First Group of Embodiments

In a nineteenth set of embodiments, the method may comprise any method of the sixth set of embodiments wherein:
the step of the client authentication device generating the transaction approval code that is linked to the second representation of the client transaction data set comprises the client authentication device generating an electronic signature of the second representation of the client transaction data set;
the transaction approval code comprises this generated electronic signature of the second representation of the client transaction data set; and
the step of the authentication server verifying whether the received transaction approval code matches the received or obtained server transaction data set comprises the authentication server verifying whether the electronic signature comprised in the transaction approval code matches the server transaction data set.

In a 20th set of embodiments, the method may comprise any method of the 19th set of embodiments, wherein the second representation of the client transaction data set is a representation of the extracted client transaction data set.

In a 21st set of embodiments, the method may comprise any method of the 19th set of embodiments, wherein the second representation of the client transaction data set is the received representation of the server transaction data set. I.e., In some embodiments, the client authentication device may generate an electronic signature of the received representation of the server transaction data set and the transaction approval code may comprise this electronic signature of the received representation of the server transaction data set; and the authentication server may verify whether the electronic signature comprised in the transaction approval code matches the server transaction data set.

Link between the transaction approval code and the client transaction data set.

The transaction approval code is generated and made available for transfer by the client authentication device only if the client authentication device has found that the received representation of the server transaction data set does indeed match the extracted client transaction data set. In other words, if the client authentication device makes an transaction approval code available for transfer then this means that the received representation of the server transaction data set matches the extracted client transaction data set. Since the transaction approval code that is made available for transfer comprises an electronic signature of the received representation of the server transaction data set which in turn has been found by the client authentication device to match the client transaction data set in the captured output, it follows that the transaction approval code that is made available for transfer is effectively linked to a representation of the client transaction data set (namely the extracted client transaction data set). In other words, the second representation of the client (i.e., first) transaction data set that the transaction approval code is linked to, is the extracted client transaction data set.

In a 22nd set of embodiments, the method may comprise any method of the 19th to 21st sets of embodiments, wherein the client authentication device generates the electronic signature of the second representation of the client transaction data set using a cryptographic algorithm that is parameterized with a secret cryptographic key. In some embodiments this secret cryptographic key may be stored in the client authentication device.

In a 23rd set of embodiments, the method may comprise any method of the 22nd set of embodiments, wherein the cryptographic algorithm is a symmetric cryptographic algorithm and the secret cryptographic key is a symmetric cryptographic key that is shared between the client authentication device and the authentication server.

In a 24th set of embodiments, the method may comprise any method of the 23rd set of embodiments, wherein the symmetric cryptographic algorithm comprises a symmetric encryption algorithm or a symmetric MAC (Message Authentication Code) algorithm or a keyed hash algorithm.

In a 25th set of embodiments, the method may comprise any method of the 22nd set of embodiments, wherein the cryptographic algorithm comprises an asymmetric cryptographic algorithm or a digital signature algorithm based on an asymmetric cryptographic algorithm and the secret cryptographic key is a private key of a public-private key pair.

### Second Group of Embodiments

In a second group of embodiments of the method, the client authentication device may sign the second representation of the client transaction data set.

In some embodiments, the step of the client authentication device generating or otherwise obtaining a transaction approval code that is linked to a second representation of the client transaction data set may comprise the client authentication device generating an electronic signature of the second representation of the client transaction data set wherein the transaction approval code comprises this generated electronic signature.

In some embodiments, the step of the client authentication device generating or otherwise obtaining a transaction approval code that is linked to a second representation of the client transaction data set may comprise the client authentication device generating the transaction approval code as an electronic signature of the second representation of the client transaction data set.

In a 26th set of embodiments, the method may comprise any method of the 2nd to 3rd sets of embodiments, wherein the step of the client authentication device generating or otherwise obtaining a transaction approval code that is linked to a second representation of the client transaction data set comprises the client authentication device generating an electronic signature of the second representation of the client transaction data set and including this generated electronic signature in the transaction approval code.

### First Subgroup of the Second Group of Embodiments

In a 27th set of embodiments, the method may comprise any method of the 26th set of embodiments, further comprising the steps of the client authentication device extracting the client transaction data set from the captured output and generating the second representation of the client transaction data set as a representation of the extracted client transaction data set.

In a 28th set of embodiments, the method may comprise any method of the 27th set of embodiments, wherein the step of the authentication server verifying whether the received transaction approval code matches the received or obtained server transaction data set may comprise the authentication server verifying whether the electronic signature of the second representation of the client transaction data set matches the server transaction data set.

### Second Subgroup of the Second Group of Embodiments

In a 29th set of embodiments, the method may comprise any method of the 26th set of embodiments, further comprising the steps of:
the client authentication device using the captured output to generate the second representation of the client transaction data as a content preserving presentation of the client transaction data;
the client authentication device sending the second representation of the client transaction data to the server;
wherein the step of the authentication server verifying whether the received transaction approval code matches the received or obtained server transaction data set comprises:
the authentication server verifying the electronic signature of the second representation of the client transaction data.

In a 30th set of embodiments, the method may comprise any method of the 29th set of embodiments, wherein the step of the authentication server verifying whether the received transaction approval code matches the received or obtained server transaction data set further comprises the authentication server verifying whether the received second representation of the client transaction data set matches the received or obtained server transaction data set.

In a 31th set of embodiments, the method may comprise any method of the 30th set of embodiments, wherein the step of the authentication server verifying whether the received second representation of the client transaction data set matches the received or obtained server transaction data set further comprises the authentication server:
extracting the client transaction data set from the received second representation of the client transaction data;
verifying whether the client transaction data set extracted from the received second representation of the client transaction data matches the received or obtained server transaction data set.

In a 32nd set of embodiments, the method may comprise any method of the 29th to 31th sets of embodiments, wherein the client authentication device does not extract the client transaction data from the captured output.

In a 33rd set of embodiments, the method may comprise any method of the 29th to 32nd sets of embodiments, wherein the step of the client authentication device using the captured output to generate the second representation of the client transaction data as a content preserving presentation of the client transaction data comprises the client authentication device:
digitizing the representation of the captured output; and
including the digitized representation of the captured output in the second representation of the client transaction data.

In a 34th set of embodiments, the method may comprise any method of the 29th to 31th sets of embodiments, wherein the step of the client authentication device using the captured output to generate the second representation of the client transaction data as a content preserving presentation of the client transaction data comprises the client authentication device:
extracting the client transaction data from the captured output;
generating the second representation of the client transaction data as a content preserving representation of the client transaction data extracted from the captured output.

### Third Group of Embodiments

In a third group of embodiments of the method, the authentication server may obtain the transaction data by receiving, from the client authentication device, a content preserving representation of the client transaction data set that has been signed by the client authentication device. Upon successfully verifying the client authentication device's electronic signature, the authentication server may extract or retrieve the client transaction data set from the received content preserving representation of the client transaction data set and adopt the extracted or retrieved client transaction data set as the server transaction data set and accept this server transaction data set for further processing by the computer-based application.

In a 35th set of embodiments, the method may comprise any method of the 1st set of embodiments, further comprising the steps of:
the client authentication device
   using the captured output to generate the second representation of the client transaction data as a content preserving presentation of the client transaction data;
   generating or otherwise obtaining a transaction approval code that is linked to a second representation of the client transaction data set by the client authentication device by:
      generating an electronic signature of the second representation of the client transaction data set; and
      including this generated electronic signature in the transaction approval code;
   sending the second representation of the client transaction data and the generated transaction approval code to the server; and
the authentication server:
   receiving the second representation of the client transaction data and the generated transaction approval code;
   verifying the electronic signature of the second representation of the client transaction data comprised in the received transaction approval code;
   extracting a transaction data set from the received second representation of the client transaction data.

In a 36th set of embodiments, the method may comprise any method of the 35th set of embodiments, further comprising the authentication server generating an approval signal for the extracted transaction data set on condition that the step of verifying the electronic signature of the second representation of the client transaction data comprised in the received transaction approval code was successful.

In a 37th set of embodiments, the method may comprise any method of the 35th to 36th sets of embodiments, further comprising the authentication server: accepting the extracted transaction data set as a server transaction data set and making the server transaction data set available for further processing, on condition that the step of verifying the electronic signature of the second representation of the client transaction data comprised in the received transaction approval code was successful.

In a 38th set of embodiments, the method may comprise any method of the 1st to 37th sets of embodiments, wherein the transaction approval code generated or obtained by the client authentication device is a cryptographic function of data that are linked to the second representation of the client transaction data set. In a 39th set of embodiments, the method may comprise any method of the 38th set of embodiments wherein that cryptographic function may be performed or calculated by the client authentication device or may be performed or calculated under control of the client authentication device. In a 40th set of embodiments, the method may comprise any method of the 38th or 39th sets of embodiments, wherein this cryptographic function may be parameterized by a secret cryptographic key. In a 41st set of embodiments, the method may comprise any method of the 40th set of embodiments, wherein the secret cryptographic key may be stored in the client authentication device or may be accessible by the client authentication device.

In some embodiments, this secret cryptographic key may by stored in a memory of the client authentication device. In other embodiments, this secret cryptographic key may be stored in a detachable component and may be accessible by the client authentication device when the component is attached to the client authentication device, i.e., the client authentication device may access the secret cryptographic key stored in the detachable component the perform or calculate the cryptographic function. In some embodiments the client authentication device accessing the secret cryptographic key stored in the detachable component may comprise the client authentication device reading, retrieving or obtaining the secret cryptographic key from the detachable component. In some embodiments the client authentication device accessing the secret cryptographic key stored in the detachable component (and performing the cryptographic function) may comprise the client authentication device delegating the cryptographic function in part or in full to the detachable component whereby the delegated part of the cryptographic function is parameterized with the secret cryptographic key stored in the detachable component, whereby the delegated part of the cryptographic function is performed by the detachable component and whereby the client authentication device determines the transaction approval code as a function of the outcome of the delegated part of the cryptographic function performed by the detachable component. In some embodiments, such a detachable component may take the form of a smart card (which may be a debit or credit card) or a SIM card. Elsewhere in this description, the detachable component may be referred to as a removable component.

The aforementioned secret cryptographic key may typically have a value that is particular for a given client authentication device or for a particular user of the client authentication device. For example in some embodiments, the values of the secret cryptographic keys stored in different client authentication devices or detachable components may be different from one client authentication device or detachable component to another. In some embodiments each client authentication device or detachable component may have a unique value for the secret cryptographic key. For example, in some embodiments, the values of the secret cryptographic keys may be generated in such a way that by construction it is guaranteed that the value of the secret cryptographic key associated with any particular client authentication device or detachable component is guaranteed to be different the value of the secret cryptographic key of any other client authentication device or detachable component. In other embodiments, the values of the secret cryptographic keys may be unique in a statistical or practical sense, i.e., in the sense that knowledge of the value of the secret cryptographic key associated with a particular client authentication device or detachable component doesn't provide an attacker with information that makes is substantially easier to obtain the value of the secret cryptographic key associated with another client authentication device or detachable component than in the absence of that knowledge. For example, in some embodiments the values of the secret cryptographic keys may be randomly selected from a very large set of possible values. In some embodiments, the size of the secret cryptographic key is at least 100 bits. In other embodiments the size of the secret cryptographic key is at least 128 bits. In still other embodiments the size of the secret cryptographic key is at least 256 bits.

In some embodiments, the secret cryptographic key may only be known to the client authentication device or detachable component. In other embodiments, the secret cryptographic key may also be known to the authentication server. In some embodiments, the secret cryptographic key may also be known to a party that is trusted from the perspective of the authentication server such as for example a provider of the client authentication device or detachable component.

In some embodiments, the cryptographic function may comprise an electronic signature algorithm that may be parameterized with the aforementioned secret cryptographic key, whereby performing the cryptographic function may comprise performing this electronic signature algorithm to generate an electronic signature of the data linked to the second representation of the client transaction data set. In some embodiments the cryptographic function may comprise a decryption algorithm that may be parameterized with the aforementioned secret cryptographic key, whereby performing the cryptographic function may comprise performing this decryption algorithm to decrypt encrypted data that are linked to the second representation of the client transaction data set.

In some embodiments, the data that are linked to the second representation of the client transaction data set are a function of the client transaction data set. For example, in some embodiments the data that are linked to the second representation of the client transaction data set are derived or calculated from the client transaction data. For example, in some embodiments the transaction approval code may be generated as a cryptographic function of a representation of the client transaction data that the client authentication device may have extracted from the output of the client access device that the client authentication device may have captured. In some embodiments, the transaction approval code generated or obtained by the client authentication device is a cryptographic function of data that are derived or otherwise linked to the server transaction data set and the client authentication device has verified that a representation of the client transaction data set matches or is equivalent to a representation of the server transaction data set. Since the client transaction data set and the server transaction data set have been found to be matching or to be equivalent, a representation of the server transaction data set is effectively a representation of the client transaction data set from which it follows that in these embodiments, wherein the transaction approval code generated or obtained by the client authentication device is a cryptographic function of data that are derived or otherwise linked to the server transaction data set, the transaction approval code is effectively also a cryptographic function of a representation of the client transaction set. For example, in some embodiments the client authentication device may receive a message comprising a representation of the server transaction data set and may generate the transaction approval code upon verifying that the received server transaction data set matches or is equivalent with a representation of the client transaction data set that it has extracted from the captured output of the client access device.

In a 42nd set of embodiments, the method may comprise any method of the 1st to 41st sets of embodiments, wherein the client authentication device using said output captured by the client authentication device to perform the step of generating or otherwise obtaining the transaction approval code and making the generated or obtained transaction approval code available for transfer, may comprise the client authentication device using the first representation of the client transaction data set comprised in the output captured by the client authentication device. In a 43rd set of embodiments, the method may comprise any method of the 1st to 42nd sets of embodiments, wherein the outcome of the step of the client authentication device using said output captured by the client authentication device to perform the step of generating or otherwise obtaining the transaction approval code and making the generated or obtained transaction approval code available for transfer, may be a function of the first representation of the client transaction data set comprised in the output captured by the client authentication device.

In some embodiments, a difference between the first representation of the client transaction data set as it is comprised in the output captured by the client authentication device and the first representation of the client transaction data set as it is comprised in the output that is output by the client access device (for example due to an error in the step of capturing said output, by the client authentication device, from the user output interface of the client access device) may result in the client authentication device generating or obtaining a different value of the transaction approval code than the value that would otherwise be generated or obtained if such difference were not present, which in turn may cause that the step of the authentication server verifying whether the received transaction approval code matches the received of obtained server transaction data set may result in the authentication server finding that the received transaction approval code does not match the received or obtained server transaction data set.

In some embodiments (e.g, in the embodiments of the 4th set of embodiments), such a difference may cause that the step of the client authentication device verifying whether the received representation of the server transaction data set matches the extracted client transaction data set may result in the client authentication device finding that the received representation of the server transaction data set does not match the extracted client transaction data set. In some embodiments, such a difference may cause the client authentication device not to perform or not to complete the step of generating or otherwise obtaining a transaction approval code that is linked to a second representation of the client transaction data set and making the generated or obtained transaction approval code available for transfer to an authentication server.

Generating and verifying electronic signatures.

In some embodiments discussed elsewhere in this description, electronic signatures are generated, by the client authentication device or by the authentication server, whereby electronic signatures generated by the client authentication device may be verified by the authentication server and some electronic signatures generated by the authentication server may be verified by the client authentication device. For example, in some embodiments the client authentication device may generate an electronic signature of a representation of the client transaction data set and may include this electronic signature in the transaction approval code. In other embodiments, the authentication server may generate an electronic signature of a message (for example comprising a representation of the server transaction data set and/or a server transaction reference code) for the client authentication device and the client authentication device may receive the message and the corresponding electronic signature and may verify the received electronic signature of the received message. In some embodiments the client authentication device may generate an electronic signature of a server transaction reference code and the authentication server may verify the electronic signature of the server transaction reference code. Various methods known in the art may be used for generating and verifying these electronic signatures.

In the following paragraph, some examples of generating and verifying these electronic signatures are discussed. While these examples focus primarily on electronic signatures of a representation of the client transaction data set, generated by the client authentication device and verified by the authentication server, it will be clear for the person skilled in the art that the same or similar techniques may also be used, mutatis mutandis, for the generation and verification of other electronic signatures used in the various embodiments of the invention, such as the electronic signatures of a server transaction reference code generated by the client authentication device and verified by the authentication server, or the electronic signatures of a message (for example comprising a representation of the server transaction data set and/or a server transaction reference code) generated by the authentication server and verified by the client authentication device.

In some embodiments the transaction approval code comprises an electronic signature over (a representation of) the client transaction data set. In some of these embodiments the electronic signature is generated as a cryptographic function of (a representation of) the client transaction data set that is parameterized by a secret cryptographic signature key. In some of these embodiments this electronic signature is generated by the client authentication device, and the secret cryptographic signature key is stored in the client authentication device. In some embodiments, the secret cryptographic key stored in the client authentication device is practically unique for each individual client authentication device.

In some embodiments the secret cryptographic signature key may be a symmetric cryptographic key that is shared by the client authentication device and the authentication server, i.e., both the client authentication device and the authentication server may each have a copy of the same cryptographic signature key value. In some embodiments, the cryptographic function for generating the electronic signature may comprise calculating a first cryptographic one-way function of (a representation of) the client transaction data set whereby the cryptographic one-way function is parameterized with the copy of the client authentication device of the secret cryptographic signature key; and the step of verifying, by the authentication server, whether the received transaction approval code is consistent with the server transaction data set may comprise calculating a second cryptographic one-way function of (a representation of) the server transaction data set whereby the second cryptographic one-way function matches the first cryptographic one-way function and is parameterized by the authentication server copy of the secret cryptographic signature key and verifying whether the received transaction approval code matches the result of calculating the second cryptographic one-way function of (a representation of) the server transaction data set. The electronic signature may for example comprise a MAC (Message Authentication Code) of (a representation of) the client transaction data set. The first and second cryptographic one-way functions may for example comprise a keyed-hash-function such as HMAC (keyed-hash message authentication code or hash-based message authentication code).

In some embodiments generating the electronic signature may comprise the client authenticating device encrypting a representation of the client transaction data set using a symmetric encryption algorithm that is parameterized with the copy of the client authentication device of the secret cryptographic signature key; and the step of verifying, by the authentication server, whether the received transaction approval code is consistent with the server transaction data set known to the authentication server may comprise decrypting the received transaction approval code using the authentication server copy of the secret cryptographic signature key and verifying whether the decrypted received transaction approval code matches (a representation of) the server transaction data set. In some embodiments the symmetric encryption algorithm may comprise for example DES (Digital Encryption Standard) or AES (Advanced Encryption Standard).

In some embodiments the secret cryptographic signature key may be the private key of an asymmetric public-private key pair whereby the authentication server may have access to the corresponding public key of the asymmetric public-private key pair. In some embodiments, the electronic signature may comprise a digital signature that the client authentication device generates using the private key with an asymmetric cryptographic algorithm for generating digital signatures (such as for example DSA (Digital Signature Algorithm), the RSA (Rivest-Shamir-Adleman) cryptosystem or the Elliptic Curve Digital Signature Algorithm (ECDSA)), and that the authentication server may verify using the corresponding public key. In some embodiments generating the electronic signature may comprise the client authenticating device encrypting a representation of the client transaction data set using an asymmetric encryption algorithm that is parameterized with the private key of the client authentication device (i.e., the client authentication device's secret cryptographic signature key); and the step of verifying, by the authentication server, whether the received transaction approval code is consistent with the server transaction data set known to the authentication server may comprise the authentication server decrypting the received transaction approval code using the matching public key and verifying whether the decrypted received transaction approval code matches (a representation of) the server transaction data set.

To prevent replay attacks, an electronic signature of a first data element (such as a representation of the client transaction data set or a server transaction reference code or a message for the client authentication device) may comprise an electronic signature of a combination of that data element with an additional dynamic second data element such as for example a sequence counter, a (random) nonce, a challenge, or a time stamp. The client authentication device may for example receive a challenge or a nonce from that authentication server or may generate a time stamp on the basis of the time indicated by a clock comprised in the client authentication device or may obtain the value of a sequence counter that it may store in its memory and update (e.g., it may increment that counter every time that the counter value is used in the generation of a transaction approval code); and the client authentication device may use the received challenge or nonce or the generated time stamp or the obtained sequence counter value in the generation of an electronic signature that may be comprised in the transaction approval code.

In some embodiments, the client access device providing an output, by means of a user output interface of the client access device, to a user of the client access device wherein the output comprises a first representation of a client transaction data set (or first transaction data set), may comprise the client access device displaying on a display of the client access device a human-readable textual representation of the client transaction data set; and the client authentication device capturing from the user output interface of the client access device the output of the client access device may comprise the client authentication device capturing an image or picture of (a part of) the output of the display of the client access device, wherein said image or picture may comprise the displayed human-readable textual representation of the client transaction data set. The client authentication device may extract a representation of the client transaction data set from the captured output. In some embodiments, the captured output may comprise an image or picture that the client authentication device may have captured (e.g., using a camera) of (a part of) the output of the display of the client access device and the client authentication device extracting a representation of the client transaction data set from the captured output may comprise extracting that representation of the client transaction data set from that captured image or picture. In some embodiments, the client access device displaying on a display of the client access device a human-readable textual representation of the client transaction data set may be done in such a way as to facilitate the capturing by the client authentication device of an image or picture of (a part of) the output of the display of the client access device that comprises the displayed human-readable textual representation of the client transaction data set, and/or it may be done in such a way as to facilitate the aforementioned extracting of a representation of the client transaction data set from that captured image or picture

In some embodiments the human-readable textual representation of the client transaction data set (or first transaction data set) in the output of the client access device may comprise a number of textual symbols from one or more writing systems (for example, numerals, letters from an alphabet, characters from a character-based writing system, . . . ). The human-readable textual representation of the client transaction data set may comprise one or more data fields. The data fields may comprise or consist of a label and a value (for example a label consisting of a text with the name of the data field and a value with the numerical, alphanumerical or textual value of the data field). The data fields may be arranged in a particular way on the display of the client access device.

In some embodiments the human-readable representation of the client transaction data set in the output of the client access device may be formatted in a particular pre-defined standardized way. For example, the representation of the first transaction data set may comprise a fixed number of data fields, the labels of the data fields may be fixed, the data fields may be represented in a fixed position, the symbols of the textual representation may be taken from a specific symbol set (such as a the Arabic numerals (‘0’, ‘1’, ‘2’, ‘3’, . . . , ‘8’, ‘9’) and a particular alphabet such as the Latin alphabet), the symbols of the textual representation may be displayed using a one or more particular fonts (such as a font that is optimised for Optical Character Recognition (OCR) techniques, see further), . . . . For example the human-readable textual representation of the client transaction data set may use (only) symbols in a particular font or in a limited set of particular fonts.

The client authentication device may have knowledge about this pre-defined standardized way of formatting the human-readable representation of the client transaction data set in the output of the client access device and may use this knowledge when capturing the output of the client access device and extracting the client transaction data set from the captured output to facilitate ensuring that the part of the output of the client access device that the client authentication device captures effectively comprises the full human-readable representation of the client transaction data set and to facilitate extracting the client transaction data set from the captured output. In some embodiments, this knowledge is implicit in the software or firmware of the client authentication device. In other embodiments, this knowledge is more explicitly coded in configuration data that are loaded into the client authentication device. In some embodiments the configuration data may be partly or completely comprised in a transaction representation template. In some embodiments the client authentication device can be dynamically configured with such a transaction representation template. In some embodiments the transaction representation template may be authenticated by a trusted party such as a provider or manufacturer of the client authentication device or the authentication server. In some embodiments the transaction representation template may be combined with or comprised in the aforementioned machine readable message comprising a representation of a server transaction data set.

In some embodiments, the client authentication device extracting the human-readable textual representation of the first transaction data set from a captured image may comprise the client authentication device applying Optical Character Recognition (OCR) techniques on the captured image. In some embodiments, the textual representation on the display of the client access device may use a font that is optimised for OCR, such as the ISO standardised OCR-B font (ISO 1073-2:1976 (E)) or the E13B/CMC7 fonts used by the banking industry on checks, to boost the OCR accuracy. In some embodiments, graphical indicators (such as delimiting lines, corners, surrounding frames, wherein these delimiting lines, corners of surrounding frames may be in a particular colour; contrasting colours between background and input fields; using particular colours for the background of the area of the display that displays the human-readable textual representation of the client transaction data set; . . . ) may be added to the textual representation on the display of the client access device to help users align the camera of the client authentication device with the area of the display of the client access device that contains the relevant data to be captured by the client authentication device and to help the client authentication device to identify the area in the captured image that contains the textual representation of the first transaction data set and/or to extract a representation of the client transaction data from the captured image, whereby the client authentication device may have or obtain knowledge of these graphical indicators and my exploit or use that knowledge to facilitate identifying the area in the captured image that contains the textual representation of the first transaction data set and/or extracting a representation of the client transaction data from the captured image. For example, in some embodiments the area of the display that displays the client transaction data set may have a particular background colour and/or that area may be delimited by a surrounding frame in another particular colour, which colours may be known to the client authentication device, and the client authentication device may advantageously use that knowledge to identify the area on the display that needs to be captured in an image or picture to capture the human-readable textual representation of the client transaction data set. Alternatively or additionally, the client access device may also display a 2D-barcode encoded with for example a machine readable message comprising a representation of a server transaction data set, whereby the displayed 2D-barcode may be encoded in a particular format (such as a QR-code format) known to the client authentication device whereby that format may itself comprise graphical indicators of the orientation and/or size of the displayed 2D-barcode, and the size and/or orientation of the area of the display that displays the human-readable textual representation of the client transaction data set may have a particular size and/or orientation relative to the size and/or orientation of the displayed 2D-barcode whereby the client authentication device may have or obtain knowledge of the relative size and/or orientation of the area of the display that displays the human-readable textual representation of the client transaction data set with respect to the size and/or orientation of the displayed 2D-barcode; and the client authentication device may advantageously exploit that knowledge to facilitate ensuring that the part of the output of the client access device that the client authentication device captures (e.g., an image of a part of the display of the client access device) effectively comprises the full human-readable representation of the client transaction data set and to facilitate extracting the client transaction data set from the captured output.

In some embodiments, the client authentication device may be adapted to capture multiple images of what the client access device is displaying and perform the process to extract the human-readable textual representation of the first transaction data set on each of the captured multiple images. If not all images yield the same resulting extracted textual representation, then in some embodiments the client authentication device may be adapted to determine the most probable textual representation that is displayed. In some embodiments, this could be determined via an algorithmic consensus finding method such as a majority vote.

In some embodiments, feature squeezing techniques may be used to thwart attacks based on adversarial samples. These feature squeezing techniques may for example comprise the techniques described in: Weilin Xu, David Evans, and Yanjun Qi. Feature Squeezing: Detecting Adversarial Examples in Deep Neural Networks. In 25th Annual Network and Distributed System Security Symposium, NDSS 2018, San Diego, California, USA, Feb. 18-21, 2018. The Internet Society, 2018 (herein incorporated in its entirety by reference).

The client authentication device, the client access device and the authentication server are typically physically distinct devices. The client authentication device and the client access device have their own different and separate user output and user input interfaces. The client authentication device and the client access device are highly preferably physically different and separate devices. In some embodiments any digital communication mechanism for automatically communicating data between the client access device and the client authentication device is one-way such that digital data can be automatically communicated from the client access device to the client authentication device but not the other way round. It is preferable that the client authentication device does not support a communication mechanism that the client access device can use to obtain information on the state of the client authentication device. In particular, it is preferable that the client authentication device does not support a communication mechanism that the client access device can use to obtain information on when the client authentication device will capture the human-readable textual representation of the first transaction data set that the client access device presents to the user.

In a typical embodiment the client authentication device and the authentication server are physically distinct devices that may be spatially remotely separated from each other. The client access and the authentication server may also typically be physically distinct devices that may be spatially remotely separated from each other.

An attacker could try to circumvent the security offered by the invention by mounting the following type of attack. For example, at the moment that the client authentication device captures the output of the client access device presenting the client transaction data to the user, the MITB malware may try to cause the transaction data that are being presented to the user by the client access device to reflect the fraudulent data instead of the transaction data that have been entered or reviewed and approved by the user. For example, the malware may just change the data hoping that the user won't notice (e.g., by doing it at a moment that the user is likely to be distracted), or do it in plain sight but give a seemingly convincing explanation (e.g., “the entered account number of the chosen recipient is no longer valid, we have already automatically updated the account number with the new correct number”).

To make this type of attack less likely to succeed, the client authentication device may also present a representation of the client transaction data to the user and ask the user to review and explicitly confirm this representation of the client transaction data on the client authentication device.

More details on the various steps of the method, on the client access device, the client authentication device and the authentication server, can be found further in this description including in the discussions of a system and an apparatus according to aspects of the invention.

In another aspect of the invention, an electronic apparatus is provided for authenticating an (electronic) transaction. In some embodiments, the electronic apparatus may comprise any of the electronic apparatus or client authentication devices described elsewhere in this description. In some embodiments, the electronic apparatus may be comprised in any of the systems described elsewhere in this description. In some embodiments, the electronic apparatus may be adapted to perform some or all of the steps of any of the methods for authenticating an (electronic) transaction described elsewhere in this description. In particular, the electronic apparatus may be adapted to perform all the steps of one of these methods that are supposed to be performed by the client authentication device mentioned in the description of the methods for authenticating an (electronic) transaction.

For example, embodiments of the electronic apparatus, the electronic apparatus comprises a client authentication device. The client authentication device comprises a memory component (110) adapted to store firmware instructions, a digital data processing component (120) connected to the memory component and adapted to execute firmware instructions stored in the memory component, and a sensor (130), such as a camera. The client authentication device may be adapted to:
capture with the sensor an output of a client access device from the user output interface of the client access device, wherein said output is output by means of a user output interface of the client access device, to a user of the client access device, and wherein the output comprises a representation of a client transaction data set (or first transaction data set), and wherein the representation of the client transaction data set (or first transaction data set) is in a format that is adapted to make it possible, and preferably also easy and convenient, for an ordinary human user to decipher and understand the data of the represented client transaction data set (or first transaction data set);
extract the client transaction data set (or first transaction data set) from said captured output;
generate an electronic signature over a representation of the extracted client transaction data set (or first transaction data set).

In a first set of embodiments of the electronic apparatus, the electronic apparatus comprises a client authentication device, the client authentication device comprising:
a memory component (110) adapted to store firmware instructions,
a digital data processing component (120) connected to the memory component and adapted to execute firmware instructions stored in the memory component, and
a sensor (130); and

the client authentication device adapted to:
capture, using said sensor, from the user output interface of a client access device an output of the client access device, wherein the output comprises a first representation of a client transaction data set, and wherein the first representation of the client transaction data set is in a format that is adapted to make it possible for human users perceiving the output to retrieve the represented client transaction data;
generate or otherwise obtain a transaction approval code that is linked to a second representation of the client transaction data set and make the generated or obtained transaction approval code available for transfer to an authentication server;
wherein the client authentication device is further adapted to use said output captured by the client authentication device in said generating or otherwise obtaining the transaction approval code and making the generated or obtained transaction approval code available for transfer.

In a second set of embodiments of the electronic apparatus, the electronic apparatus may comprise an electronic apparatus of the first set of embodiments of the electronic apparatus, wherein the client authentication device is further adapted to generate or otherwise obtain the transaction approval code as a cryptographic function of data that are linked to the second representation of the client transaction data set,

In a third set of embodiments of the electronic apparatus, the electronic apparatus may comprise any electronic apparatus of the second set of embodiments, wherein the cryptographic function is performed or calculated by the client authentication device or is performed or calculated under control of the client authentication device.

In a fourth set of embodiments of the electronic apparatus, the electronic apparatus may comprise any electronic apparatus of the second or third sets of embodiments, wherein the cryptographic function is parameterized by a secret cryptographic key.

In a fifth set of embodiments of the electronic apparatus, the electronic apparatus may comprise any electronic apparatus of the first to fourth sets of embodiments, wherein the client authentication device is further adapted to use the first representation of the client transaction data set comprised in said output captured by the client authentication device to generate or otherwise obtain the transaction approval code and make the generated or obtained transaction approval code available for transfer.

In a sixth set of embodiments of the electronic apparatus, the electronic apparatus may comprise any electronic apparatus of the first to fifth sets of embodiments, wherein the result of the client authentication device using said output captured by the client authentication device to generate or otherwise obtain the transaction approval code and make the generated or obtained transaction approval code available for transfer, is a function of the first representation of the client transaction data set comprised in the output captured by the client authentication device.

In a 7th set of embodiments of the electronic apparatus, the electronic apparatus may comprise any electronic apparatus of the 1st to 6th sets of embodiments, wherein the client authentication device is further adapted to:
extract the client transaction data set from said captured output;
receive a representation of a server transaction data set; and
verify whether the received representation of the server transaction data set matches the extracted client transaction data set.

In an 8th set of embodiments of the electronic apparatus, the electronic apparatus may comprise any electronic apparatus of the 7th set of embodiments, wherein the client authentication device if further adapted to receive a representation of the server transaction data set by:
receiving a machine readable message comprising the representation of the server transaction data set; and
extracting the representation of the server transaction data set from the received machine readable message.

In a 9th set of embodiments of the electronic apparatus, the electronic apparatus may comprise any electronic apparatus of the 7th or 8th set of embodiments, wherein the client authentication device is further adapted to generate or otherwise obtain a transaction approval code that is linked to a second representation of the client transaction data set and make the generated or obtained transaction approval code available for transfer is performed or completed by the client authentication device only if said verifying, by the client authentication device, whether the received representation of the server transaction data set matches the extracted client transaction data set, results in the client authentication device finding that the received representation of the server transaction data set indeed matches the extracted client transaction data set.

In a 10th set of embodiments of the electronic apparatus, the electronic apparatus may comprise any electronic apparatus of the 9th set of embodiments, wherein the client authentication device is further adapted to:
receive a server transaction reference code that has been generated and linked to the server transaction data set by an authentication server; and
generate the transaction approval code as a function of the server transaction reference code.

In an 11th set of embodiments of the electronic apparatus, the electronic apparatus may comprise any electronic apparatus of the 10th set of embodiments, wherein the server transaction reference code that the client authentication device receives is linked to the representation of the server transaction data set that the client authentication device receives.

In a 12th set of embodiments of the electronic apparatus, the electronic apparatus may comprise any electronic apparatus of the 11th set of embodiments, wherein the server transaction reference code that the client authentication device receives is cryptographically linked to the representation of the server transaction data set that the client authentication device receives.

In a 13th set of embodiments of the electronic apparatus, the electronic apparatus may comprise any electronic apparatus of the 10th to 12th sets of embodiments, wherein the client authentication device is further adapted to generate the transaction approval code as a function of the received server transaction reference code.

In a 14th set of embodiments of the electronic apparatus, the electronic apparatus may comprise any electronic apparatus of the 13th set of embodiments, wherein the client authentication is further adapted to generate the transaction approval code as being identical to the received server transaction reference code.

In a 15th set of embodiments of the electronic apparatus, the electronic apparatus may comprise any electronic apparatus of the 13th set of embodiments, wherein the client authentication is further adapted to generate the transaction approval code as an electronic signature of the received server transaction reference code.

In a 16th set of embodiments of the electronic apparatus, the electronic apparatus may comprise any electronic apparatus of the 9th set of embodiments, wherein the client authentication device is further adapted to generate the transaction approval code that is linked to the second representation of the client transaction data set by generating an electronic signature of the second representation of the client transaction data set and including this generated electronic signature of the second representation of the client transaction data set in the transaction approval code.

In a 17th set of embodiments of the electronic apparatus, the electronic apparatus may comprise any electronic apparatus of the 16th set of embodiments, wherein the second representation of the client transaction data set is a representation of the extracted client transaction data set.

In a 18th set of embodiments of the electronic apparatus, the electronic apparatus may comprise any electronic apparatus of the 16th set of embodiments, wherein the second representation of the client transaction data set is the received representation of the server transaction data set.

In a 19th set of embodiments of the electronic apparatus, the electronic apparatus may comprise any electronic apparatus of the 16th to 18th sets of embodiments, wherein the client authentication device is further adapted to generate the electronic signature of the second representation of the client transaction data set using a cryptographic algorithm that is parameterized with a secret cryptographic key.

In a 20th set of embodiments of the electronic apparatus, the electronic apparatus may comprise any electronic apparatus of the 19th set of embodiments, wherein the cryptographic algorithm is a symmetric cryptographic algorithm and the secret cryptographic key is a symmetric cryptographic key that is shared between the client authentication device and the authentication server.

In a 21st set of embodiments of the electronic apparatus, the electronic apparatus may comprise any electronic apparatus of the 19th set of embodiments, wherein the cryptographic algorithm comprises an asymmetric cryptographic algorithm or a digital signature algorithm based on an asymmetric cryptographic algorithm and the secret cryptographic key is a private key of a public-private key pair.

In a 22nd set of embodiments of the electronic apparatus, the electronic apparatus may comprise any electronic apparatus of the 1st to 6th sets of embodiments, wherein the client authentication device is further adapted to generate or otherwise obtain a transaction approval code that is linked to a second representation of the client transaction data set by generating an electronic signature of the second representation of the client transaction data set and including this generated electronic signature in the transaction approval code.

In a 23rd set of embodiments of the electronic apparatus, the electronic apparatus may comprise any electronic apparatus of the 22nd set of embodiments, wherein the client authentication device is further adapted to extract the client transaction data set from the captured output and generate the second representation of the client transaction data set as a representation of the extracted client transaction data set.

In a 24th set of embodiments of the electronic apparatus, the electronic apparatus may comprise any electronic apparatus of the 22nd set of embodiments, wherein the client authentication device is further adapted to use the captured output to generate the second representation of the client transaction data as a content preserving presentation of the client transaction data, and to send the second representation of the client transaction data to the authentication server.

In a 25th set of embodiments of the electronic apparatus, the electronic apparatus may comprise any electronic apparatus of the 24th set of embodiments, wherein the client authentication device does not extract the client transaction data from the captured output.

In a 26th set of embodiments of the electronic apparatus, the electronic apparatus may comprise any electronic apparatus of the 24th or 25th sets of embodiments, wherein the client authentication device using the captured output to generate the second representation of the client transaction data as a content preserving presentation of the client transaction data comprises the client authentication device:
digitizing the representation of the captured output; and
including the digitized representation of the captured output in the second representation of the client transaction data.

In a 27th set of embodiments of the electronic apparatus, the electronic apparatus may comprise any electronic apparatus of the 24th set of embodiments, wherein the client authentication device using the captured output to generate the second representation of the client transaction data as a content preserving presentation of the client transaction data comprises the client authentication device:
extracting the client transaction data from the captured output;
generating the second representation of the client transaction data as a content preserving representation of the client transaction data extracted from the captured output.

In another aspect of the invention, a system is provided for authenticating an (electronic) transaction. In some embodiments, the system may be used with any of the methods described elsewhere in this description.

In some embodiments of the system, the system may comprise:
an authentication server;
an application server comprising a computer-based application and a computer system hosting that computer-based application; and
a client authentication device.

The client authentication device may comprise any of the client authentication devices described elsewhere in this description. The application server may comprise any of the application servers described elsewhere in this description. The computer-based application may comprise any of the computer-based applications described elsewhere in this description.

The authentication server may comprise any of the authentication servers described elsewhere in this description. In particular, the authentication server may be adapted to perform any step of any of the methods for authenticating an (electronic) transaction that are described as being performed by an authentication server.

In some embodiments, the authentication server may be an integral component of the application server. For example, it may be a piece of software that is part of the computer-based application. In other embodiments, the authentication server may comprise a computer system that is distinct from the computer system of the application server and that may be connected to the application server through a computer network. The authentication server and the application server may exchange information and data. For example, the application server may provide to the authentication server a transaction data set and an electronic signature purportedly generated by the client authentication device for that transaction data set, and the authentication server may provide to the application server a machine readable message comprising a representation of the transaction data set and/or an approval signal for the second transaction data set.

In a first set of embodiments of the system, the system comprises a client authentication device and an authentication server, whereby the client authentication device may comprise any of the client authentication devices described elsewhere in this description and may in particular comprise any of the electronic apparatus of the 1st to 27th sets of embodiments of an electronic apparatus according to an aspect of the invention as described above, and whereby the authentication server may be adapted to:
receive or obtain a server transaction data set;
receive the transaction approval code that the client authentication device has generated or obtained and made available for transfer to the authentication server;
verify whether the received transaction approval code matches the received or obtained server transaction data set.

In a second set of embodiments of the system, the system may comprise any system of the first set of embodiments of the system whereby the authentication server may be further adapted to generate an approval signal for the server transaction data set if (i.e., on condition that) the authentication server's verifying whether the received transaction approval code matches the received or obtained server transaction data set results in the authentication server finding that the received transaction approval code indeed matches the received or obtained server transaction data set.

More details of the various embodiments of the different aspects of the invention described above are provided in the paragraphs below.

### BRIEF DESCRIPTION OF THE DRAWINGS

The foregoing and other features and advantages of the invention will be apparent from the following, more particular description of embodiments of the invention, as illustrated in the accompanying drawings.

FIG. 1 schematically illustrates an exemplary apparatus according to an aspect of the invention.

FIG. 2 schematically illustrates an exemplary system according to an aspect of the invention.

FIG. 3 schematically illustrates an exemplary method according to an aspect of the invention.

FIG. 4 schematically illustrates aspects of an exemplary embodiment of the invention.

### DETAILED DESCRIPTION

Some implementations of the present invention are discussed below. While specific implementations are discussed, it should be understood that this is done for illustration purposes only. A person skilled in the relevant art will recognize that other components and configurations may be used without parting from the spirit and scope of the invention. Various specific details are provided in order to enable a thorough understanding of the invention. However, it will be understood by a person skilled in the relevant art that the present invention may be practiced without these specific details. In other instances, well-known methods, procedures, components and circuits have not been described in detail so as not to obscure the present invention. Various modifications to the described embodiments will be apparent to persons skilled in the art, and the general principles of the embodiments described in detail below may be applied to other embodiments.

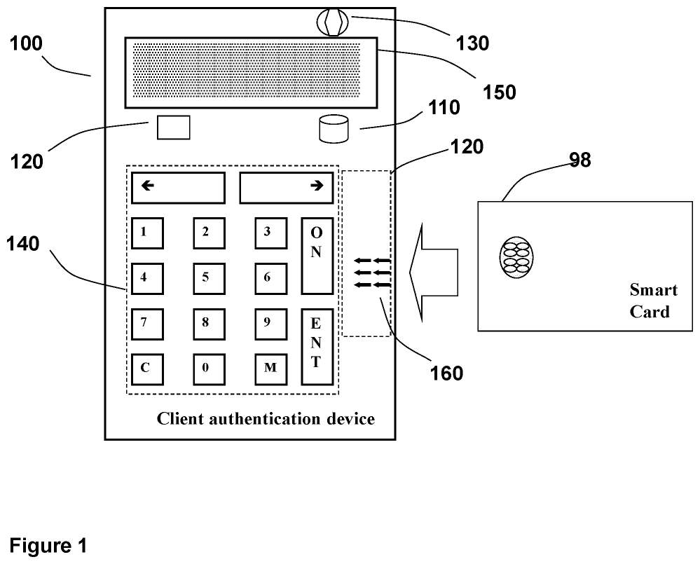

FIG. 1 schematically illustrates an exemplary electronic apparatus, i.e., a client authentication device, according to an aspect of the invention.

In one embodiment, a client authentication device (100) according to the invention may comprise the following components: a memory component (110), a digital data processing component (120), a sensor (130). In some embodiments the electronic apparatus (100) may comprise additional components such as: a user input interface (140) such as for example a keyboard, a user output interface (150) such as for example a display (for example an LCD—Liquid-Crystal Display), additional digital communication interfaces (160) to interface with one or more other electronic devices or removable components (98), such as for example one or more smart card readers to communicate with an inserted smart card (98), such as a banking smart card (for example an EMV (Europay-Mastercard-VISA) debit or credit card), or a SIM (Subscriber Identity Module) card, and a power supply such as a battery or a power cable. The one or more other electronic devices or removable components (98) may comprise the detachable component mentioned elsewhere in this description.

The client authentication device may be adapted to generate or otherwise obtain a transaction approval codes (such as for example electronic signatures) or dynamic authentication credentials. In some embodiments, the client authentication device may be dedicated to a security related function such as for example securing the interaction of a user with a computer system by generating or otherwise obtaining transaction approval codes that are linked to particular transactions (such as electronic signatures) and/or dynamic authentication credentials, such as One-Time Passwords (OTPs), and making these transaction approval codes and/or dynamic authentication credentials available for transfer to an authentication server. It may for example comprise an (intelligent and secure) smart card reader. In other embodiments, it may for example comprise a personal electronic device that is not dedicated to a security related function but that may also support multiple other functions, such as a smartphone or a smartwatch comprising a client authentication app.

The memory component (110) may be adapted to store firmware instructions for the digital data processing component (120) to read and execute. The memory component (110) may be further adapted to store data for the digital data processing component (120) to read, process and write. For example, the memory component (110) may be further adapted to store cryptographic keys and/or secrets such as the secret cryptographic key that may be used in the process of the client authentication device generating or obtaining the transaction approval code, e.g., in the process of generating or obtaining the transaction approval code generated or obtained by the client authentication device as a cryptographic function of data that are linked to the second representation of the client transaction data set, wherein the cryptographic function may be performed or calculated by the client authentication device or may be performed or calculated under control of the client authentication device, and wherein the cryptographic function is parameterized by this secret cryptographic key. The memory component may comprise volatile and/or non-volatile memory, such as for example one or more RAM (Random Access Memory) chips, ROM (Read-Only Memory) chips, EEPROM (Electrically Erasable Programmable Read-Only Memory), flash memory, hard disk drives, . . . .

The digital data processing component (120) may be connected, for example by means of a bus, to the memory component (110) and various other components of the electronic apparatus such as the aforementioned sensor (130), user input interface, user output interface and additional digital communication interfaces. The digital data processing component (120) may be adapted to read and execute firmware instructions stored on the memory component (110). The digital data processing component (120) may be adapted to read digital data that are stored on or in the memory component, to process digital data and to store digital data on or in the memory component. The digital data processing component (120) may be adapted to control various components of the electronic apparatus such as the aforementioned sensor (130), user input interface, user output interface and additional digital communication interfaces.

The sensor (130) is adapted to capture an analog output of a client access device. For example, the sensor may comprise a microphone to record for example a synthesized speech signal emitted by a loudspeaker of the client access device; or the sensor may comprise a camera to take one or more pictures of (a part of) an image displayed by the display of the client access device.

The functionality of the client authentication device may be at least partly defined and implemented by the firmware stored on the memory component to be read and executed by the digital data processing component.

In some embodiments, all the components of the client authentication device may be comprised in a single monolithic housing. On some embodiments, this housing may consist of a casing that may be partly or fully made of plastic or that may be partly or entirely made of metal. In some embodiments, one or more of the removable components (98), such as a SIM card, may be semi-permanently comprised in a housing of the client authentication device. I.e., a removable component (98) may be comprised in the housing of the client authentication device whereby this removable component (98) ordinarily remains in place but whereby it is possible to open the housing of the client authentication device and remove this removable component (98) and replace it by another removable component. In other embodiments at least one of the removable components is not comprised in the housing of the client authentication device. In some embodiments a removable component, such as an EMV smart card, may be temporarily connected to the client authentication device to be used by the client authentication device for performing its functionality, for example, when performing one or more of the steps of any of the methods for authenticating an (electronic) transaction described elsewhere in this description, that may be performed by a client authentication device, whereby the removable component may typically be ordinarily disconnected and removed again after usage of the client authentication device.

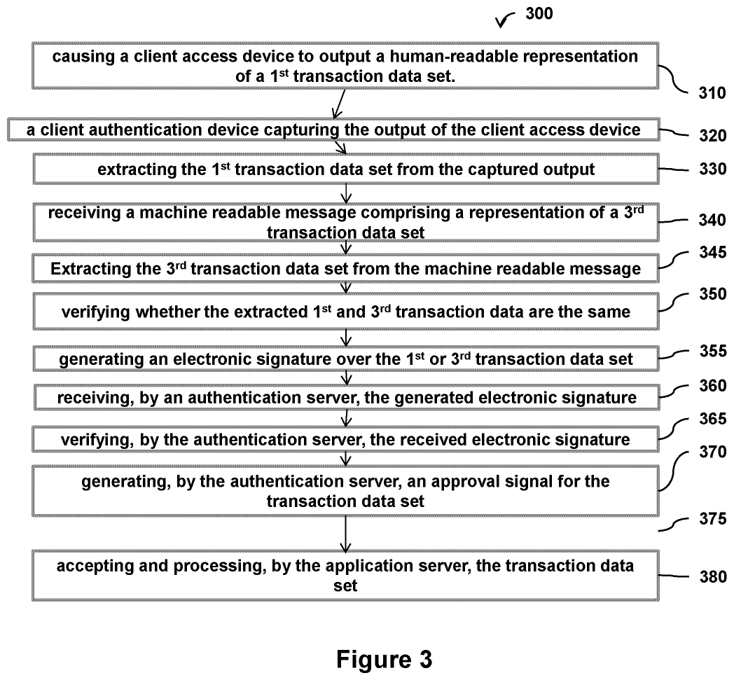

In some embodiments, the client authentication device may be adapted to perform the steps of any of the methods for authenticating an (electronic) transaction described elsewhere in this description, that may be performed by a client authentication device. The client authentication device may for example be adapted to perform one or more or all of the steps of the methods described in the discussion of FIG. 3, that may be carried out by the client authentication device.

For example, the client authentication device may be adapted to perform the following actions as part of a method for authenticating an (electronic) transaction:
capturing from the user output interface of a client access device an output of the client access device, wherein the output comprises a first representation of a client transaction data set, and wherein the first representation of the client transaction data set is in a format that is adapted to make it possible for human users perceiving the output to retrieve the represented client transaction data;
generating or otherwise obtaining a transaction approval code that is linked to a second representation of the client transaction data set and making the generated or obtained transaction approval code available for transfer to an authentication server;
wherein the client authentication device uses said output captured by the client authentication device to perform the step of generating or otherwise obtaining the transaction approval code and making the generated or obtained transaction approval code available for transfer.

In some embodiments, the transaction approval code generated or obtained by the client authentication device is a cryptographic function of data that are linked to the second representation of the client transaction data set, In some embodiments, the cryptographic function is performed or calculated by the client authentication device or is performed or calculated under control of the client authentication device. In some embodiments, the cryptographic function is parameterized by a secret cryptographic key. In some embodiments, the secret cryptographic key is stored in or accessible by the client authentication device.

In some embodiments, the client authentication device using said output captured by the client authentication device to perform the step of generating or otherwise obtaining the transaction approval code and making the generated or obtained transaction approval code available for transfer, comprises the client authentication device using the first representation of the client transaction data set comprised in said output captured by the client authentication device.

In some embodiments, the outcome of the step of the client authentication device using said output captured by the client authentication device to perform the step of generating or otherwise obtaining the transaction approval code and making the generated or obtained transaction approval code available for transfer, is a function of the first representation of the client transaction data set comprised in the output captured by the client authentication device.

In particular, in some embodiments the client authentication device may be adapted to perform the following actions as part of a method for authenticating an (electronic) transaction:
capturing an (analog) output of a client access device from the user output interface of the client access device, wherein said output is output by means of a user output interface of the client access device, to a user of the client access device, and wherein the output comprises a representation of a client transaction data set (or first transaction data set), and wherein the representation of the client transaction data set (or first transaction data set) is in a format that is adapted to make it possible, and preferably also easy and convenient, for an ordinary human user to decipher and understand the data of the represented client transaction data set (or first transaction data set);
extracting said client transaction data set (or first transaction data set) from said captured output;
generating an electronic signature over a representation of the extracted client transaction data set (or first transaction data set).

The client authentication device may be further adapted to perform the following additional actions as part of a method for authenticating an (electronic) transaction:
receiving a machine readable message comprising a representation of a third transaction data set;
extracting the third transaction data set from the received machine readable message; and
verifying whether the extracted third transaction data set and the extracted client transaction data set (or first transaction data set) define the same transaction.

Further details of these actions can be found elsewhere in this description, in particular in the discussion of FIG. 3.

In some embodiments, the client authentication device may be adapted to use a removable or detachable component (98) to perform one or more of the actions or steps that the client authentication device performs as part of a method for authenticating an (electronic) transaction. For example, in some embodiments the client authentication device may use a removable or detachable component (98) as a secure element for performing security sensitive operations such as storing secret information (such as PINs, passwords, secret cryptographic data, . . . ) and/or for performing cryptographic functions. A removable or detachable component (98) may be personalized for a specific user, i.e., it may be associated with a specific user and may comprise data the values of which are associated with that specific user and are specific for that user. For example, a removable or detachable component (98) may store in its memory a reference value for a PIN or password or a biometric template specific for a user associated with the removable or detachable component (98), and/or it may store in its memory a value of a secret cryptographic key that is specific for that user. In some embodiments, the transaction approval code generated or obtained by the client authentication device is a cryptographic function of data that are linked to the second representation of the client transaction data set and the client authentication device may perform this cryptographic function by relying on the removable or detachable component (98) to perform a cryptographic algorithm that may perform a part or the entirety of this cryptographic function whereby the cryptographic algorithm may be parameterized by said secret cryptographic key stored in the memory of the removable or detachable component (98). Another action or step that the client authentication device may perform as part of a method for authenticating an (electronic) transaction and that the client authentication may use the removable or detachable component (98) to perform this action or step is for example authenticating the user. In some embodiments, the client authentication device may for example receive from the user a PIN or password or biometric data and may provide the removable or detachable component (98) data related to this PIN or password or biometric data and the removable or detachable component (98) may compare this data related to this PIN or password or biometric data with reference data stored in the removable or detachable component (98) and the removable or detachable component (98) may communicate the result of this comparison to the client authentication device. In general, in some embodiments the client authentication device may be adapted to use a removable or detachable component (98) to perform one or more of the actions or steps that the client authentication device performs as part of a method for authenticating an (electronic) transaction by exchanging a series of one or more commands and responses with the removable or detachable component (98) whereby the one or more commands may indicate which actions the removable or detachable component (98) must perform and may comprise data that the removable or detachable component (98) must process when performing these actions and whereby the one or more responses may comprise results of these actions. For example, in some embodiments the removable or detachable component (98) may comprise a smart card and the series of one or more commands and responses may consist of a series of smart card APDUs (application protocol data unit), e.g., ISO/IEC 7816-4 smart card APDUs. In some embodiments, the smart card may comprise an EMV compliant smart card and the series of smart card APDUs may be EMV APDUs.

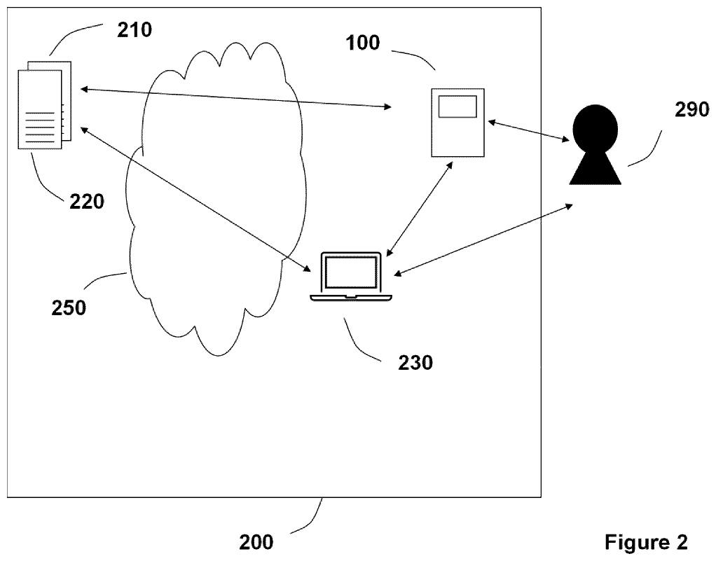

In some embodiments, the discussed client authentication device may be comprised in any of the systems described elsewhere in this description. In particular, the client authentication device may be comprised in any of the systems described in the discussion of FIG. 2.

FIG. 2 schematically illustrates an exemplary system according to an aspect of the invention.

In one embodiment a system (200) according to the invention may comprise the following components:
a client authentication device (100);
an application server (210), comprising a computer-based application and a first computer system hosting a computer-based application, the first computer system comprising a first set of one or more computers;
an authentication server (220), comprising a second computer system, the second computer system comprising a second set of one or more computers.

The client authentication device (100) may comprise any of the client authentication devices described elsewhere in this description, in particular the client authentication device described in the discussion of FIG. 1. In some embodiments, the client authentication device may be adapted to perform the steps of any of the methods for authenticating an (electronic) transaction described elsewhere in this description, that may be performed by a client authentication device. The client authentication device may for example be adapted to perform one or more or all of the steps of the methods described in the discussion of FIG. 3, that may be carried out by the client authentication device.

The one or more computers of the application server (210) and/or authentication server (220) may comprise: one or more digital data processing components for processing digital data, such as for example a microprocessor or a CPU (Central Processing Unit); one or more memory components for storing data or instructions (e.g., software) to be performed by the digital data processing components, like for example a RAM (Random Access Memory) memory or a hard disk, a network interface component, like an Ethernet interface, for connecting the one or more computers of the computer systems of the application server (210) and the authentication server (220) to each other and/or to a computer network (250) like for example the internet and/or (through computer network (250)) to the client authentication device (100) and/or a client access device (230).

The authentication server (220) may be adapted to perform one or more or all of the steps of a method for authenticating an (electronic) transaction described elsewhere in this description, that are described as being performed by an authentication server. In particular, in some embodiments the authentication server (220) may be adapted to perform one or more or all of the following steps:
receiving a transaction approval code (such as an electronic signature) generated by the client authentication device;
verifying whether the received transaction approval code is consistent with a server transaction data set (or second transaction data set) known to the authentication server (whereby this server transaction data set (or second transaction data set) may be a client transaction data set (or first transaction data set) that it has received from the application server); and
generating an approval signal for the server transaction data set (or second transaction data set) in case that said verifying whether the received transaction approval code (such as an electronic signature) is consistent with the server transaction data set (or second transaction data set) indicates that the received transaction approval code (such as an electronic signature) is indeed consistent with the server transaction data set (or second transaction data set).

In some embodiments, the authentication server may be comprised as an integral component in the application server.

The application server (210) may be adapted to perform one or more or all of the steps of a method for authenticating an (electronic) transaction described elsewhere in this description, that are described as being performed by an application server. In particular, in some embodiments the application server (210) may be adapted to perform one or more or all of the following steps:
receiving a client transaction data set (or first transaction data set), for example from the client access device, as a transaction data set submitted by the user;
causing the client access device (100) to provide an output, by means of a user output interface of the client access device, to a user of the client access device wherein the output comprises a representation of the client transaction data set (or first transaction data set), and wherein the representation of the client transaction data set (or first transaction data set) is in a human-readable format;
determining a server transaction data set as a function of the received client transaction data set;
providing the server transaction data set to the authentication server;
receiving from the authentication server (220) an approval signal for the server transaction data set:
upon receiving the approval signal, accepting and processing a transaction corresponding to the client transaction data set or the server transaction data set.

The client access device (230) may for example comprise a general purpose personal client computing device such as for example a PC (personal computer), a laptop or a tablet computer. The client access device (230) may comprise one or more digital data processing components for processing digital data, such as for example a microprocessor or a CPU (Central Processing Unit); one or more memory components, such as for example a RAM (Random Access Memory) memory or a hard disk, for storing data or instructions (e.g., software such as an operating system like the Windows, Unix, Linux, Apple IOS or the Android operating systems) to be performed by the digital data processing components. The client access device (230) may further also comprise a network interface component, like an Ethernet interface, for connecting the client access device (230) to the application server (210) and/or authentication server (220).

A user (290) may use the client access device (230) to interact with the computer-based application hosted by the application server (210). For example, the user may use a web browser comprised in the client access device to access a web interface of the computer-based application.

The computer network (250) may connect the one or more computers of the computer systems of the application server (210) and/or authentication server (220) with each other, with the client access device (230), and, in some cases, with the client authentication device (100). In some embodiments, the computer network (250) may comprise the internet. In some embodiments, the computer network (250) may comprise a public telephone network. In some embodiments, the computer network (250) may comprise a wireless telephony network or a wireless data communication network.

FIG. 3 schematically illustrates an exemplary method for authenticating an (electronic) transaction according to an aspect of the invention.

In some embodiments, a method (300) according to the invention may comprise the following steps:
causing (310) a client access device to provide an output, by means of a user output interface of the client access device, to a user of the client access device wherein the output comprises a representation of a first (client) transaction data set, and wherein the representation of the first (client) transaction data set is in a human-readable format;
capturing (320), by a client authentication device, from the user output interface of the client access device said output of the client access device;
extracting (330), by the client authentication device, said first (client) transaction data set from said captured output;
generating or obtaining (355), by the client authentication device, a transaction approval code such as an electronic signature over a representation of the extracted first (client) transaction data set.

In some embodiments, the method (300) may comprise the following additional steps:
receiving (360), by an authentication server, the transaction approval code (such as the electronic signature) generated or obtained by the client authentication device;
verifying (365), by the authentication server, whether the received transaction approval code (such as the electronic signature) is consistent with a second (server) transaction data set known to the authentication server; and
generating (370), by the authentication server, an approval signal for the second (server) transaction data set in case that said verifying whether the received transaction approval code (electronic signature) is consistent with the second (server) transaction data set indicates that the received transaction approval code (electronic signature) is indeed consistent with the second (server) transaction data set;
receiving, by the application server, the approval signal and accepting and processing (380) the first (client) transaction data set.

In some embodiments, the method (300) may further comprise the following additional steps:
receiving (340), by the client authentication device, a machine readable message comprising a representation of a third transaction data set;
extracting (345), by the client authentication device, the third transaction data set from the received machine readable message; and
verifying (350), by the client authentication device, whether the extracted third transaction data set and the extracted first (client) transaction data set define the same transaction.

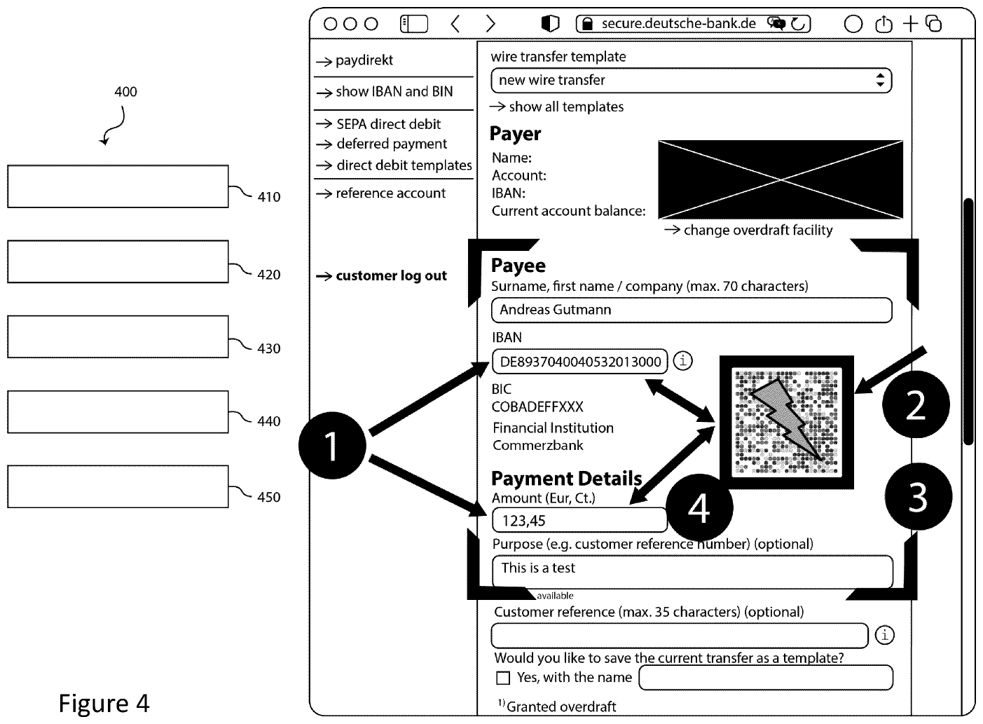

FIG. 4 schematically illustrates aspects of an exemplary embodiment of the invention. This exemplary embodiment may contain optional features that are not necessarily present in some other embodiments of the invention. Conversely, certain optional features that may be present in some other embodiments of the invention may be absent from this exemplary embodiment.

This exemplary embodiment comprises a method (400) which may comprise the following steps:
Step 1: The user enters transaction data on the webpage of the computer-based application, and the application server of the computer-based application receives the entered transaction data (410).
Step 2: The Website displays the 2D barcode on the same page on which the transaction data is entered by the user and displayed to the user in a human-readable format (i.e., a textual format) (420). In some embodiments the Display 2D barcode is displayed once all the transaction data have been entered. In some embodiments, the 2D barcode is updated if some data is changed, e.g., if the user corrected a typo. Alternatively, the contents of 2D barcode may be sent directly to a client authentication device that may be connected to the application or authentication server.
Step 3: The user scans the 2D barcode and the unencrypted transaction data with their client authentication device (at the same time) (430).
Step 4: The client authentication device automatically compares the human readable representation of the transaction data and the server transaction data set encoded in the 2D barcode (440).
Step 5: The client authentication device displays a TAN if the human readable representation of the transaction data and the server transaction data set encoded in the 2D barcode match and shows a warning or error message otherwise (450).

In other words, the client authentication device gets both the human-readable representation of the client transaction data set that the user sees on the webpage on their client access device and a machine-readable representation of the server transaction data set as known to the server and can verify whether these two transaction data sets match, whereby it doesn't matter whether the user checks the correctness of the transaction data on the client authentication device or on the screen of the client access device.

In this example, the computer-based application is an internet banking website. The user wants to submit a money transfer transaction. In a first step the user enters (1) the data of the money transfer transaction. The transaction data consist of a number of fields including the receiving account (field label: “IBAN”, field value: “DE89370400440532013000”) and the amount (field label: “Amount (EUR, Ct.)”, field value: “123,45”). The application or authentication server of the internet banking website generates a color-coded 2D Barcode encoded with a digital message comprising the essential transaction data as received by the internet banking website's application server, i.e., a server transaction data set. This 2D barcode may be displayed (2) on the same page where the user has entered the transaction data (which may remain displayed throughout). With the user's client authentication device, the user then scans the relevant part (i.e., the part containing the 2D barcode and the transaction data related to the amount and receiving account) of the webpage that is being displayed, i.e., the client authentication device takes a picture of the relevant part of the webpage being displayed. The client authentication device extracts the 2D barcode and the textual representation of the transaction data from the picture it has taken. The client authentication device extracts on the one hand a client transaction data set (or first transaction data set) from the human readable textual representation of the transaction data and it extracts on the other hand a representation of a server transaction data set (or third transaction data set) encoded in the 2D barcode. The client authentication device then automatically compares (4) the client transaction data set (or first transaction data set) and the representation of the server transaction data set (or third transaction data set). If it finds that there is a match between the client transaction data set (or first transaction data set) and the representation of the server transaction data set (or third transaction data set), for example, if it finds that both transaction data sets are identical, the client authentication device generates or otherwise obtains a transaction approval code. This transaction approval code may be directly or indirectly cryptographically linked to the client transaction data set. More in particular, the transaction approval code may be generated or obtained by the client authentication device applying a cryptographic function to data that is (directly or indirectly) linked to a (representation of) the client transaction data set (whereby it is to be noted that data linked to server transaction data set is automatically deemed to be also indirectly linked to the client transaction data set if the client authentication device finds, upon comparing the extracted client transaction data set and the received server transaction data set, that there is a match between the extracted client transaction data set and the received server transaction data set. The aforementioned cryptographic function may preferably be parameterized with a secret key that may be stored in a memory of the client authentication device or that may be accessible by the client authentication device. That secret key may be personalized, i.e., the secret key used by a particular client authentication device may have a value that is particular for that client authentication device or for the user of that client authentication device. For example, in some embodiments the client authentication device may generate the transaction approval code as an electronic signature (for example, in the form of a One-Time Password (OTP) or a Transaction Authentication Number (TAN)) over a representation of the transaction, for example over the client transaction data set (or first transaction data set) or over the representation of the server transaction data set (or third transaction data set). In other embodiments, the transaction approval code may have been generated by an authentication server of the internet banking website and included together with the representation of the server transaction data set (or third transaction data set) in the 2D barcode (whereby the transaction approval code and the representation of the server transaction data set (or third transaction data set) may be cryptographically linked together in the 2D barcode, for example they may be combined in a data structure that may have been encrypted by the authentication server and upon reception may be decrypted by the client authentication device). To obtain the transaction approval code, the client authentication device extracts the transaction approval code from the 2D barcode. The transaction approval code generated or otherwise obtained by the client authentication device is then transferred to the internet banking website. For example, if the client authentication device comprises a smartphone, the client authentication device may send it directly to an authentication server associated with the internet banking website; or, for example if the client authentication device comprises a dedicated hardware device (e.g., a so-called strong authentication token), the client authentication device may display the transaction approval code (which may have the form of an OTP or a TAN) on its display and the user may copy the transaction approval code displayed by the client authentication device into an appropriate field of the webpage and submit it to the internet banking website which in turn may forward the received transaction approval code to the authentication server associated with the internet banking website. The authentication server may then verify whether the transaction approval code it has received from the client access device matches the transaction data that is has received. If the authentication server finds that the received transaction approval code indeed matches the received transaction data, it may send the application of the internet banking website an approval signal whereupon the internet banking application may accept and process the transaction.

Advantages and disadvantages of the invention or various embodiments of the invention. The invention has the advantage that it provides a mechanism for authenticating electronic transactions that is easy and convenient for users to use and that is secure, robust and reliable in the sense that it protects against MITMA attacks because it provides a transaction approval code that is linked to the transaction data that the user sees on the user interface of the client access device that the user uses to submit the transaction (whereby this link is cryptographically protected), without the user having to review a second time the transaction data on the trusted display of the trusted client authentication device and without the need for a trusted client access device. This significantly increases the overall security of the system. Indeed, while it has been found that a significant number of users in reality approve the transaction data that a secure client authentication device presents without actually verifying whether these presented transaction data effectively correspond to the intended transaction, the inventor has had the insight that many users of online banking applications are worried about the risk of inadvertently entering or providing erroneous transaction data (which may result in a possibly irrevocable erroneous money transfer to a wrong party) and spend a lot of effort in ensuring that the transaction data that they enter into their client access device are correct. Because with the system of the invention there is no necessity for the user to review a second time the transaction data on the trusted display of the trusted client authentication device, the display of the trusted client authentication device of the invention can be very simple which reduces the costs of the trusted client authentication device.

Easy migration path. Furthermore, if a security system is already in place whereby the user has a client authentication device that captures from the display of the user's client access device a 2D barcode that is encoded with a transaction data set and that subsequently generates a transaction approval code (such as an electronic signature) as a function of the transaction data in the captured 2D barcode, then this security system can be upgraded to a system according to the invention whereby the client authentication device additionally also captures the transaction data displayed to the user on the client access device's display and compares these captured transaction data with a representation of the transaction data in the 2D barcode, whereby this upgrade necessitates very little changes (if any) in the routine and habits of the user since the only thing that changes is that the client authentication device now must capture both the 2D barcode and the transaction data that is displayed to the user (instead of only the 2D barcode). This minor and easy to understand change requires very little education of the user and thus little additional costly helpdesk workload. Moreover, this upgrade is backwards compatible in the sense that the old client authentication devices can still be used with the upgraded application since the new version of the application may still use the same 2D barcodes as the old version of the application.

A number of implementations have been described. Nevertheless, it will be understood that various modifications may be made. For example, elements of one or more implementations may be combined, deleted, modified, or supplemented to form further implementations. Accordingly, other implementations are within the scope of the appended claims. In addition, while a particular feature of the present invention may have been disclosed with respect to only one of several implementations, such feature may be combined with one or more other features of the other implementations as may be desired and advantageous for any given or particular application. While various embodiments of the present invention have been described above, it should be understood that they have been presented by way of example only, and not limitation. In particular, it is, of course, not possible to describe every conceivable combination of components or methodologies for purposes of describing the claimed subject matter, but one of ordinary skill in the art may recognize that many further combinations and permutations of the present invention are possible. Thus, the breadth and scope of the present invention should not be limited by any of the above described exemplary embodiments; rather the scope of at least one embodiment of the invention is defined only in accordance with the following claims and their equivalents.

What is claimed is:

1.-72. (canceled)

73. A method for authenticating an electronic transaction, the method comprising steps of:
causing a client access device to provide an output, by using a user output interface of the client access device, to a user of the client access device wherein the output comprises a first representation of a client transaction data set, and wherein the first representation of the client transaction data set is in a format that is adapted to make it possible for human users perceiving the output to retrieve the represented client transaction data set;
capturing, by a client authentication device, from the user output interface of the client access device said output of the client access device;
generating or otherwise obtaining, by the client authentication device, a transaction approval code that is linked to a second representation of the client transaction data set and making the generated or obtained transaction approval code available for transfer to an authentication server using said output captured by the client authentication device;
receiving or obtaining, by the authentication server, a server transaction data set;
receiving, by the authentication server, the transaction approval code that the client authentication device has generated or obtained and made available for transfer to the authentication server;
verifying, by the authentication server, whether the received transaction approval code matches the received or obtained server transaction data set;
extracting, by the client authentication device, the client transaction data set from said captured output;
receiving, by the client authentication device, a representation of the server transaction data set comprising receiving a machine readable message comprising the representation of the server transaction data set and extracting the representation of the server transaction data set from the received machine readable message; and
verifying, by the client authentication device, whether the received representation of the server transaction data set matches the extracted client transaction data set.

74. The method of claim 73, further comprising the steps of:
the authentication server generating a server transaction reference code and linking the generated server transaction reference code to the server transaction data set; and
the client authentication device receiving the server transaction reference code;
wherein the step of the client authentication device generating or otherwise obtaining the transaction approval code that is linked to a second representation of the client transaction data set comprises the client authentication device generating the transaction approval code as a function of the server transaction reference code;
wherein the step of the authentication server generating a server transaction reference code and linking the generated server transaction reference code to the server transaction data set comprises:
the authentication server generating the server transaction reference code as a cryptographic function of the server transaction data set wherein the cryptographic function is parameterised by a secret server transaction reference code generation key; or
the authentication server generating a transaction reference code seed and storing the generated transaction reference code in association with the server transaction set; and
wherein the step of the authentication server verifying whether the received transaction approval code matches the received or obtained server transaction data set comprises the authentication server retrieving or re-generating the server transaction reference code that is linked to the server transaction data set and verifying whether the received transaction approval code matches the retrieved or re-generated transaction reference code.

75. The method of claim 73, wherein:
the step of the client authentication device generating the transaction approval code that is linked to the second representation of the client transaction data set comprises the client authentication device generating an electronic signature of the second representation of the client transaction data set;
the transaction approval code comprises this generated electronic signature of the second representation of the client transaction data set; and
the step of the authentication server verifying whether the received transaction approval code matches the received or obtained server transaction data set comprises the authentication server verifying whether the electronics signature comprised in the transaction approval code matches the server transaction data set,
wherein the second representation of the client transaction data set is a representation of the extracted client transaction data set or is the received representation of the server transaction data set.

76. The method of claim 74, wherein the step of the client authentication device generating or otherwise obtaining a transaction approval code that is linked to a second representation of the client transaction data set comprises the client authentication device generating an electronic signature of the second representation of the client transaction data set and including this generated electronic signature in the transaction approval code.

77. The method of claim 75, wherein the step of the client authentication device generating or otherwise obtaining a transaction approval code that is linked to a second representation of the client transaction data set comprises the client authentication device generating an electronic signature of the second representation of the client transaction data set and including this generated electronic signature in the transaction approval code.

78. The method of claim 73, further comprising the steps of:
the client authentication device:
using the captured output to generate the second representation of the client transaction data as a content preserving presentation of the client transaction data;
generating or otherwise obtaining a transaction approval code that is linked to a second representation of the client transaction data set by the client authentication device by:
generating an electronic signature of the second representation of the client transaction data set; and
including this generated electronic signature in the transaction approval code;
sending the second representation of the client transaction data and the generated transaction approval code to the server; and
the authentication server:
receiving the second representation of the client transaction data and the generated transaction approval code;
verifying the electronic signature of the second representation of the client transaction data comprised in the received transaction approval code;
extracting a transaction data set from the received second representation of the client transaction data;
generating an approval signal for the extracted transaction data set on condition that the step of verifying the electronic signature of the second representation of the client transaction data comprised in the received transaction approval code was successful; and
accepting the extracted transaction data set as a server transaction data set and making the server transaction data set available for further processing, on condition that the step of verifying the electronic signature of the second representation of the client transaction data comprised in the received transaction approval code was successful;
wherein the transaction approval code generated or obtained by the client authentication device is a cryptographic function of data that are linked to the second representation of the client transaction data set.

79. An electronic apparatus comprising a client authentication device, the client authentication device comprising: a memory component adapted to store firmware instructions, a digital data processing component connected to the memory component and adapted to execute firmware instructions stored in the memory component, and a sensor; wherein the client authentication device is adapted to:
capture with said sensor from a user output interface of a client access device an output of the client access device, wherein the output comprises a first representation of a client transaction data set, and wherein the first representation of the client transaction data set is in a format that is adapted to make it possible for human users perceiving the output to retrieve the represented client transaction data set;
generate or otherwise obtain a transaction approval code that is linked to a second representation of the client transaction data set and make the generated or obtained transaction approval code available for transfer to an authentication server;
wherein the client authentication device is further adapted to use said output captured by the client authentication device in said generating or otherwise obtaining the transaction approval code and making the generated or obtained transaction approval code available for transfer;
extract the client transaction data set from said captured output;
receive a representation of a server transaction data set; and
verify whether the received representation of the server transaction data set matches the extracted client transaction data set; and
receive a representation of the server transaction data set by:
receiving a machine readable message comprising the representation of the server transaction data set; and
extracting the representation of the server transaction data set from the received machine readable message.

80. The electronic apparatus of claim 79, wherein the client authentication device is further adapted to use the first representation of the client transaction data set comprised in said output captured by the client authentication device to generate or otherwise obtain the transaction approval code and make the generated or obtained transaction approval code available for transfer, and
wherein the result of the client authentication device using said output captured by the client authentication device to generate or otherwise obtain the transaction approval code and make the generated or obtained transaction approval code available for transfer, is a function of the first representation of the client transaction data set comprised in the output captured by the client authentication device.

81. The electronic apparatus of claim 79, wherein the client authentication device is further adapted to:
receive a server transaction reference code that has been generated and linked to the server transaction data set by an authentication server, wherein the server transaction reference code is linked to the representation of the server transaction data set that the client authentication device receives; and
generate the transaction approval code as a function of the server transaction reference code.

82. The electronic apparatus of claim 81, wherein the client authentication device is further adapted to generate the transaction approval code as a function of the received server transaction reference code.

83. The electronic apparatus of claim 80, wherein the client authentication device is further adapted to:
receive a server transaction reference code that has been generated and linked to the server transaction data set by an authentication server, wherein the server transaction reference code is linked to the representation of the server transaction data set that the client authentication device receives; and
generate the transaction approval code as a function of the server transaction reference code.

84. The electronic apparatus of claim 83, wherein the client authentication device is further adapted to generate the transaction approval code as a function of the received server transaction reference code.

85. The electronic apparatus of claim 79, wherein the client authentication device is further adapted to generate the transaction approval code that is linked to the second representation of the client transaction data set by generating an electronic signature of the second representation of the client transaction data set and including this generated electronic signature of the second representation of the client transaction data set in the transaction approval code; and
wherein the second representation of the client transaction data set is a representation of the extracted client transaction data set or is the received representation of the server transaction data set.

86. The electronic apparatus of claim 79, wherein the client authentication device is further adapted to generate or otherwise obtain a transaction approval code that is linked to a second representation of the client transaction data set by generating an electronic signature of the second representation of the client transaction data set and including this generated electronic signature in the transaction approval code.

87. The electronic apparatus of claim 80, wherein the client authentication device is further adapted to generate or otherwise obtain a transaction approval code that is linked to a second representation of the client transaction data set by generating an electronic signature of the second representation of the client transaction data set and including this generated electronic signature in the transaction approval code.

88. The electronic apparatus of claim 86, wherein the client authentication device is further adapted to use the captured output to generate the second representation of the client transaction data as a content preserving presentation of the client transaction data, and to send the second representation of the client transaction data to the authentication server.

89. The electronic apparatus of claim 88, wherein the client authentication device does not extract the client transaction data from the captured output.

90. The electronic apparatus of claim 88, wherein the client authentication device using the captured output to generate the second representation of the client transaction data as a content preserving presentation of the client transaction data comprises the client authentication device:
digitizing the representation of the captured output; and
including the digitized representation of the captured output in the second representation of the client transaction data.

91. The electronic apparatus of claim 88, wherein the client authentication device using the captured output to generate the second representation of the client transaction data as a content preserving presentation of the client transaction data comprises the client authentication device:
extracting the client transaction data from the captured output; and
generating the second representation of the client transaction data as a content preserving representation of the client transaction data extracted from the captured output.

92. A system comprising the electronic apparatus of claim 79 and an authentication server that is adapted to:
receive or obtain a server transaction data set;
receive the transaction approval code that the client authentication device has generated or obtained and made available for transfer to the authentication server; and
verify whether the received transaction approval code matches the received or obtained server transaction data set;
whereby the authentication server is further adapted to generate an approval signal for the server transaction data set if the authentication server's verifying whether the received transaction approval code matches the received or obtained server transaction data set results in the authentication server finding that the received transaction approval code matches the received or obtained server transaction data set.
